(19) United States
(12) Patent Application Publication
(10) Pub. No.: US 2026/0001786 A1
(43) Pub. Date: Jan. 1, 2026

(54) METHODS OF CHANGING ION CONCENTRATIONS IN SURFACE WATER, AND SYSTEMS THEREOF

(71) Applicant: UTI LIMITED PARTNERSHIP, CALGARY (CA)

(72) Inventors: ARTHI GOPALAKRISHNAN, CALGARY (CA); STEPHEN RICHARD LARTER, CALGARY (CA); VENKATARAMAN THANGADURAI, CALGARY (CA); JAGOS RADOVIC, HOUSTON, TX (US); RENZO CORREA SILVA, AIRDRIE (CA); PRATHAP IYAPAZHAM VAIGUNDA SUBA, CALGARY (CA); BENJAMIN TUTOLO, CAMBRIDGE (GB)

(21) Appl. No.: 18/992,358

(22) PCT Filed: Jul. 7, 2023
(86) PCT No.: PCT/CA2023/050922

§ 371 Date: Jan. 8, 2025

Related U.S. Application Data
(60) Provisional application No. 63/359,327, filed on Jul. 8, 2022.

(51) Int. Cl. C02F 1/461; C02F 103/00; C02F 103/08; C25B 1/135

(52) U.S. Cl. CPC C02F 1/46109; C25B 1/135; C02F 2001/46133; C02F 2103/007; C02F 2103/08; C02F 2201/46105

(57) ABSTRACT

Methods and systems of changing ion concentrations in a water, involving extracting and providing ions from and to water masses or aliquots, where extracting and providing said ions may motivate partitioning of CO₂ into the water.

### CROSS REFERENCE TO RELATED APPLICATION

This application claims priority to United States Provisional Patent Application number U.S. 63/359,327, filed Jul. 8, 2022, the entire contents of which are hereby incorporated by reference.

### FIELD

The present disclosure relates generally to water alkalinity enhancements, and carbon removal and capture.

### BACKGROUND

Scenarios for keeping global warming:2° C. by 2100 project the use of carbon capture, such as carbon dioxide removal (CDR) technologies, on the scale of 100-1000 gigatons (Gt) CO₂ over this century (IPCC, 2013). The amount of excess atmospheric carbon that will have to be removed poses a technological challenge for carbon removal technologies currently under development, such as bioenergy with carbon capture and storage (BECCS) or direct CO₂ capture from the air (DAC) combined with carbon storage. Such approaches may deal with megaton (Mt) levels of carbon removal, though scaling them to Gt amounts of CO₂ tends to be significantly constrained by the availability and suitability of subsurface storage reservoirs and land surface competition/disturbance needed for deployment.

### INTRODUCTION

For carbon capture and storage, the marine environment is of interest because of the large volume/area available for possible CO₂ absorption. In addition, global oceans already store and cycle carbon pools on the appropriate Gt scales, for example, the ocean stores ˜600 Gt of carbon as complex, recalcitrant organic mixtures, and in excess of ˜30,000 Gt of carbon in inorganic, bicarbonate form (Jiao et al., 2010). Natural concentrations of organic and inorganic carbon species in the ocean are relatively low (micro- to milli-molar level); therefore, it may be possible to store large additional amounts of carbon in the ocean, without perturbing natural biogeochemical pools and cycles past their tipping points.

Scoping studies suggest that one of the most efficient routes to removing CO₂ from the atmosphere is to locally raise the pH of the near surface ocean water whereby CO₂ dissolves and becomes converted to bicarbonate ion (Kheshgi, 1995). This route tends to require the addition of a basic compound such as calcium hydroxide. To do this at scale tends to require the mining, processing, and shipping of large quantities of alkaline rocks (such as limestone) and/or their processed hydroxide or oxide products. While this may be technically feasible, it would likely require the addition of a mining industry on the scale of the current global mining enterprise, plus huge onshore mines and calcining facilities in order to facilitate the strategy. The calcining process itself could release large amounts of CO₂ which would need to be captured and stored.

A non-calcining route to producing calcium hydroxide has been described (Rau, Gregory Hudson. “Electrochemical formation of hydroxide for enhancing carbon dioxide and acid gas uptake by a solution.” U.S. Pat. No. 8,177,946, issued May 15, 2012). The device described for producing the calcium hydroxide consisted of an electrochemical system which electrolyzed water in the presence of calcium carbonate in an anode compartment to produce calcium hydroxide in a cathode compartment. The device was based around an electrolyzer which also produced hydrogen. However, the device required the provision of a solid carbonate mineral in the anode compartment.

Described herein is an alternate electrochemical route to providing metal ions to an electrolyzer for hydroxide ion generation. As described herein, generation of hydroxide ion in an electrolyzer through electrolysis—while it may be beneficial—is not required to accelerate CO₂ uptake from the atmosphere. Instead, this may be achieved through judicious manipulation of near surface seawater chemistry charge balance, via ion extraction and migration between deeper and shallower seawater sections.

### SUMMARY

In an aspect of the present disclosure, there is provided a method of changing ion concentrations in a surface water, the method comprising providing a first solution comprising a first concentration of ions to an electrochemical cell positioned at a first distance from the surface water; electrochemically absorbing the ions from the first solution into an electrode of the electrochemical cell to form a second solution comprising a second concentration of the ions, the second concentration being less than the first concentration; removing the second solution from the electrochemical cell; providing a third solution comprising a third concentration of the ions; electrochemically desorbing the ions from the electrode of the electrochemical cell into the third solution to form a fourth solution comprising a fourth concentration of the ions, the fourth concentration being greater than the third concentration; and providing the fourth solution from the electrochemical cell to a second distance from the surface water.

In an embodiment of the present disclosure, there is provided a method further comprising increasing concentrations of inorganic carbon species in the surface water following providing the fourth solution to the second distance from the surface water.

In another embodiment there is provided a method wherein the ions comprise alkali metal cations, alkaline earth metal cations, or a combination thereof.

In another embodiment there is provided a method wherein the first distance from the surface water is distal from the surface, and the second distance from the surface water is proximal to the surface.

In another embodiment there is provided a method wherein the ions comprise halide anions, polyatomic anions, or a combination thereof.

In another embodiment there is provided a method wherein the first distance from the surface water is proximal from the surface, and the second distance from the surface water is distal to the surface.

In another embodiment there is provided a method wherein providing the fourth solution from the electrochemical cell to a second distance from the surface water comprises: moving the electrochemical cell from the first distance to the second distance; or fluidly communicating the fourth solution from the electrochemical cell to the second distance.

In another embodiment there is provided a method further comprising providing the fourth solution from the electrochemical cell to an electrolyzer for producing hydrogen gas and hydroxide anions. In another embodiment there is provided a method wherein providing the first solution to the electrochemical cell comprises producing hydrogen gas and hydroxide anions at a counter electrode of the electrochemical cell. In another embodiment there is provided a method wherein providing the third solution to the electrochemical cell comprises producing hydrogen gas and hydroxide anions at a counter electrode of the electrochemical cell.

In another embodiment there is provided a method further comprising providing the hydroxide anions to the surface water, and increasing concentrations of inorganic carbon species in the surface water.

In another aspect of the present disclosure, there is provided a system configured to perform the method as described herein.

In another aspect of the present disclosure, there is provided a system, comprising: an electrochemical cell, the electrochemical cell configured for accepting a first solution comprising a first concentration of ions, electrochemically absorbing the ions from the first solution into an electrode of the electrochemical cell to form a second solution comprising a second concentration of the ions, the second concentration being less than the first concentration, removing the second solution from the electrochemical cell; accepting a third solution comprising a third concentration of the ions; electrochemically desorbing the ions from the electrode of the electrochemical cell into the third solution to form a fourth solution comprising a fourth concentration of the ions, the fourth concentration being greater than the third concentration, and removing the fourth solution from the electrochemical cell; and a mass transport device coupled to the electrochemical cell for providing the first solution and dispersing the fourth solution.

In an embodiment of the present disclosure, there is provided a system wherein the system is powered by renewable energy sources.

In another embodiment there is provided a system wherein the mass transport system comprises pumps and pipes in fluid communication with the electrochemical cell, for providing the first solution to the electrochemical cell and dispersing the fourth solution from the electrochemical cell.

In another embodiment there is provided a system wherein the mass transport system comprises an autonomous submersible vehicle for positioning the electrochemical cell at a first distance from a surface water, and/or for positioning the electrochemical cell at a second distance from a surface water.

In another embodiment there is provided a system the first distance from the surface water is distal from the surface, and the second distance from the surface water is proximal to the surface; or the first distance from the surface water is proximal from the surface, and the second distance from the surface water is distal to the surface.

In another embodiment there is provided a system wherein the first distance or the second distance is proximal to an underwater seamount.

### BRIEF DESCRIPTION OF THE FIGURES

Embodiments of the present disclosure will now be described, by way of example only, with reference to the attached Figures.

FIG. 1 depicts thermodynamic models demonstrating the impact of changing surface seawater sodium or chloride ion concentration by 1% on the dissolved bicarbonate content of seawater at equilibrium with atmospheric CO₂. Increasing sodium ion concentration or decreasing chloride ion concentration produced increases in dissolved bicarbonate content of seawater in equilibrium with atmospheric CO₂.

FIG. 2 depicts a dual iron phosphate electrode system able to simultaneously extract sodium ions from one parcel of seawater and add sodium ions to another parcel of seawater.

FIG. 3 depicts a configuration of an overall carbon dioxide removal system.

FIG. 4 depicts a generic assembly of ion selective electrodes and flow paths for a PEACH system.

FIG. 5 depicts a schematic illustration of an electrochemical setup to move Ca²⁺ ions in water streams from deep ocean to a water stream at the surface ocean.

FIG. 6 depicts (a) and (b) structure of K₂BaFe(CN)₆ showing the potassium ion stripping step and the calcium ion insertion step. (c) Galvanostatic potassium stripping step and calcium insertion step (d) cyclic voltammetry showing the calcium insertion/de-insertion potential (e) EDS results showing as prepared electrode, potassium stripping, calcium insertion and calcium stripping steps.

FIG. 7 depicts (a) and (b) SEM and EDS of as prepared electrode. (c) and (d) SEM image and EDS of K⁺ ions stripped electrode. (e) and (f) SEM image and EDS of Ca²⁺ ions inserted electrode. (g) and (h) SEM and EDS of Ca²⁺ ions stripped electrode.

FIG. 8 depicts—(a) and (b) Galvanostatic monitoring of potassium ion stripping and calcium ion insertion step (c) Capacity vs potential for different loadings of K₂BaFe(CN)₆ (d) Mass loading vs moles of K⁺ and Ca²⁺ ions stripped and inserted in the K₂BaFe(CN)₆ structure.

FIG. 9 depicts the Charge/Discharge cycle with K₂BaFe(CN)₆ as working electrode, reference electrode Ag/AgCl (sat. KCl) and the counter electrode is a graphite rod. The electrolyte is 3.5% sea salt in DI water in which calcium concentration is 10 mM.

FIG. 10 depicts (a) Powder XRD pattern of synthesized K₂BaFe(CN)₆ (b) SEM image of as-synthesized K₂BaFe(CN)₆.

FIG. 11 depicts an exemplary use of a herein described PEACH electrochemical system for modifying (A) cation concentrations and (B) anion concentrations in waters from a geothermal energy recovery system.

FIG. 12 depicts an exemplary use of a herein described PEACH electrochemical system for modifying ion concentrations in waters from a petroleum production well.

FIG. 13 depicts (a) Electrochemical insertion of Na⁺ ions into FePO₄ electrode and (b) Electrochemical expulsion of Na⁺ ions from electrode to seawater.

FIG. 14 depicts continuous pH monitoring of the seawater solutions during (a) Na⁺ ions insertion into electrode and (b) Na⁺ ions expulsion into seawater.

FIG. 15 depicts (a) Electrochemical insertion of Cl⁻ ions into polypyrrole electrode and (b) Electrochemical expulsion of Cl⁻ ions from polypyrrole electrode to seawater.

FIG. 16 depicts (a) Electrolysis process for the splitting of water (b) Na⁺ ions insertion and expulsion steps.

FIG. 17 depicts a schematic of the steps involved in the Na⁺ insertion/expulsion steps with H⁺ ion storage electrodes as counter electrode (a) deep ocean (b) surface ocean.

FIG. 18 depicts an exemplary use of a herein described PEACH electrochemical system for modifying ion concentrations in ocean waters, where the counter electrode of the cell is a gas-evolution electrode.

FIG. 19 depicts an exemplary use of a herein described PEACH electrochemical system for modifying ion concentrations in ocean waters, where the counter electrode of the cell is a H⁺ ion storage/expulsion electrode.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein refers to the list following as being non-exhaustive and may or may not include any other additional suitable items, for example one or more further feature(s), component(s) and/or ingredient(s) as appropriate.

Large-scale removal of carbon dioxide from the atmosphere is part of plans to stabilize climate towards the end of the 21^{st} century. Various routes have been proposed. A location for carbon capture and storage is in marine environments. In marine environments, carbon is stored primarily as inorganic bicarbonate ions, dissolved organic species or matter (DOM), and as particulate organic material that sinks and is incorporated partly in marine sediments.

Generally, the present disclosure provides a method of changing ion concentrations in a surface water, the method comprising providing a first solution from a first distance relative to the surface water to an electrochemical cell, the first solution comprising a first concentration of ions; electrochemically absorbing the ions from the first solution into an electrode of the electrochemical cell to form a second solution comprising a second concentration of the ions, the second concentration being less than the first concentration; removing the second solution from the electrochemical cell; providing a third solution comprising a third concentration of the ions; electrochemically desorbing the ions from the electrode of the electrochemical cell into the third solution to form a fourth solution comprising a fourth concentration of the ions, the fourth concentration being greater than the third concentration; and providing the fourth solution from the electrochemical cell to a second distance relative to the surface water.

Further, the present disclosure generally provides a method of changing ion concentrations in a surface water, the method comprising providing a first solution comprising a first concentration of ions to an electrochemical cell positioned at a first distance from the surface water; electrochemically absorbing the ions from the first solution into an electrode of the electrochemical cell to form a second solution comprising a second concentration of the ions, the second concentration being less than the first concentration; removing the second solution from the electrochemical cell; providing a third solution comprising a third concentration of the ions; electrochemically desorbing the ions from the electrode of the electrochemical cell into the third solution to form a fourth solution comprising a fourth concentration of the ions, the fourth concentration being greater than the third concentration; and providing the fourth solution from the electrochemical cell to a second distance from the surface water.

The present disclosure also generally provides a method of changing ion concentrations in a surface water, the method comprising providing a first solution comprising a first concentration of ions to an electrochemical cell at a first distance from the surface water; electrochemically absorbing the ions from the first solution into an electrode of the electrochemical cell to form a second solution comprising a second concentration of the ions, the second concentration being less than the first concentration; removing the second solution from the electrochemical cell; providing a third solution comprising a third concentration of the ions; electrochemically desorbing the ions from the electrode of the electrochemical cell into the third solution to form a fourth solution comprising a fourth concentration of the ions, the fourth concentration being greater than the third concentration; and providing the fourth solution from the electrochemical cell to a second distance from the surface water.

In an example of the present disclosure, there is provided a method further comprising increasing concentrations of inorganic carbon species in the surface water following providing the fourth solution to the second distance from the surface water.

In another example there is provided a method wherein the ions comprise alkali metal cations, alkaline earth metal cations, or a combination thereof. In another example there is provided a method wherein the ions comprise alkali metal cations, alkaline earth metal cations, or a combination thereof, such as sodium, calcium, or a combination thereof.

In another example there is provided a method wherein the first distance from the surface water is distal from the surface, and the second distance from the surface water is proximal to the surface. In another example there is provided a method wherein proximal to the surface comprises being within the surface water.

In another example there is provided a method wherein the ions comprise halide anions, polyatomic anions, or a combination thereof. In another example there is provided a method wherein the ions comprise halide anions, polyatomic anions, or a combination thereof, such as chloride.

In another example there is provided a method wherein the first distance from the surface water is proximal from the surface, and the second distance from the surface water is distal to the surface. In another example there is provided a method wherein proximal to the surface comprises being within the surface water.

In another example there is provided a method wherein providing the fourth solution from the electrochemical cell to a second distance from the surface water comprises: moving the electrochemical cell from the first distance to the second distance; or fluidly communicating the fourth solution from the electrochemical cell to the second distance.

In another example there is provided a method further comprising providing the fourth solution from the electrochemical cell to an electrolyzer for producing hydrogen gas and hydroxide anions. In another embodiment there is provided a method wherein providing the first solution to the electrochemical cell comprises producing hydrogen gas and hydroxide anions at a counter electrode of the electrochemical cell. In another embodiment there is provided a method wherein providing the third solution to the electrochemical cell comprises producing hydrogen gas and hydroxide anions at a counter electrode of the electrochemical cell.

In another example there is provided a method further comprising providing the hydroxide anions to the surface water, and increasing concentrations of inorganic carbon species in the surface water.

Generally, the present disclosure also provides a system configured to perform the method as described herein.

Generally, the present disclosure also provides a system, comprising: an electrochemical cell, the electrochemical cell configured for accepting a first solution comprising a first concentration of ions, electrochemically absorbing the ions from the first solution into an electrode of the electrochemical cell to form a second solution comprising a second concentration of the ions, the second concentration being less than the first concentration, removing the second solution from the electrochemical cell; accepting a third solution comprising a third concentration of the ions; electrochemically desorbing the ions from the electrode of the electrochemical cell into the third solution to form a fourth solution comprising a fourth concentration of the ions, the fourth concentration being greater than the third concentration, and removing the fourth solution from the electrochemical cell; and a mass transport device coupled to the electrochemical cell for providing the first solution and dispersing the fourth solution.

In an example of the present disclosure, there is provided a system wherein the system is powered by renewable energy sources.

In another example there is provided a system wherein mass transport system comprises pumps and pipes in fluid communication with the electrochemical cell, for providing the first solution to the electrochemical cell and dispersing the fourth solution from the electrochemical cell.

In another example there is provided a system wherein the mass transport system comprises an autonomous submersible vehicle for positioning the electrochemical cell at a first distance from a surface water, and/or for positioning the electrochemical cell at a second distance from a surface water.

In another example there is provided a system the first distance from the surface water is distal from the surface, and the second distance from the surface water is proximal to the surface; or the first distance from the surface water is proximal from the surface, and the second distance from the surface water is distal to the surface.

In another example there is provided a system wherein the first distance or the second distance is proximal to an underwater seamount.

In one or more examples, the present disclosure generally provides:
1. A method of changing ion concentrations for forming inorganic carbon species, the method comprising
providing a first aqueous solution comprising a first concentration of ions to an electrochemical cell;
electrochemically absorbing the ions from the first aqueous solution into an electrode of the electrochemical cell to form a second aqueous solution comprising a second concentration of the ions, the second concentration being less than the first concentration;
discharging the second aqueous solution from the electrochemical cell;
providing a third aqueous solution comprising a third concentration of the ions to the electrochemical cell;
electrochemically desorbing the ions from the electrode of the electrochemical cell into the third aqueous solution to form a fourth aqueous solution comprising a fourth concentration of the ions, the fourth concentration being greater than the third concentration;
discharging the fourth aqueous solution from the electrochemical cell; and
forming inorganic carbon species from a CO₂ source.
2. The method of example 1, wherein the first aqueous solution is sourced from a first waterbody, and the third aqueous solution is sourced from a second waterbody.
3. The method of example 1 or 2, wherein the first waterbody and second waterbody are sourced from the same waterbody.
4. The method of any one of examples 1 to 3, wherein the first waterbody and second waterbody are sourced from different waterbodies.
5. The method of any one of examples 1 to 4, wherein the first waterbody comprises a surface water, an intermediate water, a deep water, or a subterranean water.
6. The method of any one of examples 1 to 5, wherein the first waterbody comprises freshwater, brackish water, seawater, wastewater, produced water, recycled water, subterranean water, or a combination thereof.
7. The method of any one of examples 1 to 6, wherein the second waterbody comprises a surface water, an intermediate water, a deep water, or a subterranean water.
8. The method of any one of examples 1 to 7, wherein the second waterbody comprises freshwater, brackish water, seawater, wastewater, produced water, recycled water, subterranean water, or a combination thereof.
9. The method of any one of examples 1 to 8, wherein the ions comprise alkali metal cations, alkaline earth metal cations, or a combination thereof.
10. The method of any one of examples 1 to 9, wherein the ions comprise halide anions, polyatomic anions, or a combination thereof.
11. The method of any one of examples 1 to 10, wherein the electrochemical cell comprises a galvanic cell, voltaic cell, an electrolytic cell, a fuel cell, a battery, or a combination thereof.
12. The method of any one of examples 1 to 11, wherein the electrochemical cell comprises a counter electrode, the counter electrode comprising a gas-evolving electrode.
13. The method of example 12, or any one of examples 1 to 12, wherein the gas-evolving electrode produces hydrogen gas and hydroxide anions.
14. The method of any one of examples 1 to 11, or any one of examples 1 to 13, wherein the electrochemical cell comprises a counter electrode, the counter electrode comprising a hydrogen-storing electrode.
15. The method of example 14, or any one of examples 1 to 14, wherein the electrochemical cell is a battery.
16. The method of any one of examples 1 to 15, further comprising discharging the hydroxide anions from the electrochemical cell and increasing concentration of the inorganic carbon species formed from the CO₂ source.
17. The method of any one of examples 1 to 16, wherein the CO₂ source comprises a CO₂-comprising gas, a dissolved CO₂, or a combination thereof.
18. The method of any one of examples 1 to 17, wherein the CO₂ source comprises air, anthropogenic CO₂-comprising gases, or CO₂ dissolved therefrom.
19. The method of any one of examples 1 to 18, further comprising storing the inorganic carbon species.
20. The method of example 19, or any one of examples 1 to 19, wherein storing the inorganic carbon specifies comprises storing in a water or a reservoir.
21. The method of example 20, or any one of examples 1 to 20, wherein the water comprises freshwaters, brackish waters, seawaters, or a combination thereof.
22. The method of example 20 or 21, or any one of examples 1 to 21, wherein the water comprises a surface water.
23. The method of any one of examples 20 to 22, or any one of examples 1 to 22, wherein the reservoir comprises a subterranean reservoir.
24. The method of example 1 to 23, wherein forming the inorganic carbon species comprises forming the inorganic carbon species in a surface water.
25. The method of example 24, or any one of examples 1 to 24, wherein forming the inorganic carbon species comprises forming the inorganic carbon species from atmospheric CO₂ in contact with the surface water.
26. The method of example 24 or 25, or any one of examples 1 to 25, wherein forming the inorganic carbon species comprises forming the inorganic carbon species from atmospheric CO₂ dissolved in the surface water.
27. The method of any one of examples 24 to 26, or any one of examples 1 to 26, wherein providing the first aqueous solution comprises providing the first aqueous solution from a first position distanced from the surface water.
28. The method of any one of examples 24 to 27, or any one of examples 1 to 27, wherein discharging the fourth aqueous solution comprises discharging the fourth aqueous solution to a second position distanced from the surface water.
29. The method of any one of examples 24 to 28, or any one of examples 1 to 28, wherein when the ions comprise alkali metal cations, alkaline earth metal cations, or a combination thereof, the first position distanced from the surface water is distal from the surface water, and the second position distanced from the surface water is within the surface water.
30. The method of any one of examples 24 to 28, or any one of examples 1 to 29, wherein when the ions comprise halide anions, polyatomic anions, or a combination thereof, the first position distanced from the surface water is within the surface water, and the second position distanced from the surface water is distal to the surface water.
31. The method of any one of examples 24 to 30, or any one of examples 1 to 30, wherein providing the third aqueous solution comprises providing the third aqueous solution from a third position distanced from the surface water.
32. The method of example 31, or any one of examples 1 to 31, wherein the third position comprises a position proximal or equivalent to the first position; a position proximal or equivalent to the second position; or a position between the first and second positions.
33. The method of any one of examples 24 to 32, or any one of examples 1 to 32, wherein providing the first aqueous solution to the electrochemical cell comprises: moving the electrochemical cell to the first position distanced from the surface water; or fluidly communicating the first aqueous solution to the electrochemical cell from the first position distanced from the surface water.
34. The method of any one of examples 24 to 33, or any one of examples 1 to 33, wherein discharging the fourth aqueous solution from the electrochemical cell comprises: moving the electrochemical cell from the first position to the second position distanced from the surface water; or fluidly communicating the fourth aqueous solution from the electrochemical cell to the second position distanced from the surface water.
35. The method of any one of examples 24 to 34, or any one of examples 1 to 34, wherein providing the third aqueous solution to the electrochemical cell comprises: moving the electrochemical cell to the third position distanced from the surface water; or fluidly communicating the third aqueous solution to the electrochemical cell from the third position distanced from the surface water.
36. The method of any one of examples 24 to 35, or any one of examples 1 to 35, wherein, when the ions comprise alkali metal cations, alkaline earth metal cations, or a combination thereof, forming the inorganic carbon species comprises increasing concentrations of the inorganic carbon species in the surface water following discharging the fourth aqueous solution to the second position distanced from the surface water.
37. The method of any one of examples 24 to 35, or any one of examples 1 to 36, wherein, when the ions comprise halide anions, polyatomic anions, or a combination thereof, forming the inorganic carbon species comprises increasing concentrations of the inorganic carbon species in the surface water following discharging the second aqueous solution from the electrochemical cell.
38. The method of example 37, or any one of examples 1 to 37, wherein discharging the second aqueous solution from the electrochemical cell comprises discharging within the surface water.
39. The method of example 37 or 38, or any one of examples 1 to 38, wherein discharging the second aqueous solution from the electrochemical cell comprises: moving the electrochemical cell to be positioned within the surface water; or fluidly communicating the second aqueous solution from the electrochemical cell to within the surface water.
40. The method of any one of examples 24 to 39, or any one of examples 1 to 39, wherein, when the electrochemical cell comprises the gas-evolving electrode, the method further comprises producing hydrogen gas and hydroxide anions.
41. The method of example 40, or any one of examples 1 to 40, further comprising providing the hydroxide anions to the surface water, and increasing concentrations of inorganic carbon species in the surface water.
42. The method of any one of examples 24 to 41, or any one of examples 1 to 41, wherein the surface water comprises freshwater, brackish water, seawater, wastewater, produced water, recycled water, or a combination thereof.
43. The method of any one of examples 24 to 42, or any one of examples 1 to 42, wherein the surface water comprises freshwater, brackish water, seawater, or a combination thereof.
44. The method of any one of examples 24 to 43, or any one of examples 1 to 43, wherein, when the ions comprise alkali metal cations, alkaline earth metal cations, or a combination thereof, the first position distanced from the surface water is within intermediate or deep water, and the second position distanced from the surface water is within the surface water.
45. The method of any one of examples 24 to 43, or any one of examples 1 to 44, wherein when the ions comprise halide anions, polyatomic anions, or a combination thereof, the first position distanced from the surface water is within the surface water, and the second position distanced from the surface water is within intermediate or deep water.
46. The method of example 1 to 23, or any one of examples 1 to 45, wherein forming the inorganic carbon species comprises forming the inorganic carbon species in a subterranean water.
47. The method of example 46, or any one of examples 1 to 46, wherein providing the first aqueous solution comprises providing the first aqueous solution from a first subterranean reservoir.
48. The method of example 46 or 47, or any one of examples 1 to 47, wherein providing the third aqueous solution comprises providing the third aqueous solution from the first subterranean reservoir, a second subterranean reservoir, or a combination thereof.
49. The method of any one of examples 46 to 48, or any one of examples 1 to 48, wherein, when the ions comprise alkali metal cations, alkaline earth metal cations, or a combination thereof, forming the inorganic carbon species comprises forming the inorganic carbon species by contacting the discharged fourth aqueous solution with the CO₂ source.
50. The method of example 49, or any one of examples 1 to 49, wherein contacting the discharged fourth aqueous solution with the CO₂ source comprises sparging, or equilibrating the discharged fourth aqueous solution with the CO₂ source.
51. The method of any one of examples 46 to 48, or any one of examples 1 to 50, wherein when the ions comprise halide anions, polyatomic anions, or a combination thereof, forming the inorganic carbon species comprises forming the inorganic carbon species by forming the inorganic carbon species by contacting the discharged second aqueous solution with the CO₂ source.
52. The method of example 51, or any one of examples 1 to 51, wherein contacting the discharged second aqueous solution with the CO₂ source comprises sparging, or equilibrating the discharged second aqueous solution with the CO₂ source.
53. The method of any one of examples 46 to 52, or any one of examples 1 to 52, wherein discharging the fourth aqueous solution comprises discharging the fourth aqueous solution to the first subterranean reservoir, the second subterranean reservoir, a third subterranean reservoir, or a combination thereof.
54. The method of any one of examples 46 to 53, or any one of examples 1 to 53, wherein discharging the second aqueous solution comprises discharging the second aqueous solution to the first subterranean reservoir, the second subterranean reservoir, the third subterranean reservoir, a fourth subterranean reservoir, or a combination thereof.
55. The method of any one of examples 46 to 54, or any one of examples 1 to 54, wherein providing the first aqueous solution to the electrochemical cell comprises: fluidly communicating the first aqueous solution to the electrochemical cell from the first subterranean reservoir.
56. The method of any one of examples 46 to 55, or any one of examples 1 to 55, wherein providing the third aqueous solution to the electrochemical cell comprises: fluidly communicating the third aqueous solution to the electrochemical cell from the first subterranean reservoir, the second subterranean reservoir, or a combination thereof.
57. The method of any one of examples 46 to 56, or any one of examples 1 to 56, wherein discharging the fourth aqueous solution from the electrochemical comprises: fluidly communicating the fourth aqueous solution from the electrochemical cell to the first subterranean reservoir, the second subterranean reservoir, the third subterranean reservoir, or combination thereof.
58. The method of any one of examples 46 to 57, or any one of examples 1 to 57, wherein discharging the second aqueous solution from the electrochemical cell comprises: fluidly communicating the fourth aqueous solution from the electrochemical cell the first subterranean reservoir, the second subterranean reservoir, the third subterranean reservoir, the fourth subterranean reservoir, or a combination thereof.
59. The method of any one of examples 46 to 58, or any one of examples 1 to 58, wherein the CO₂ source comprises air, an anthropogenic CO₂-comprising gas, a dissolved CO₂, or a combination thereof.
60. The method of any one of examples 46 to 59, or any one of examples 1 to 59, wherein any one or combination of the first subterranean reservoir, the second subterranean reservoir, the third subterranean reservoir, the fourth subterranean reservoir comprises a geothermal reservoir, a drilled well, an oil and gas well, a reinjection well, or a combination thereof.

In another example, the present disclosure generally provides:
61. A electrochemical cell configured to perform the method of any one of examples 1 to 60, the cell comprising a working electrode and a counter electrode, the counter electrode comprising a hydrogen-storing electrode.
62. The cell of example 61, wherein the hydrogen-storing electrode comprises MoS₂; Mg, Ni, and/or Co alloys; MoS₂-carbon composites; Mg, Ni, and/or Co alloy-carbon composites; or a combination thereof.
63. The cell of example 61 or 62, wherein carbon of the carbon composites comprises graphene, fullerene, carbon nanotubes, or a combination thereof.
64. The cell of any one of examples 61 to 63, wherein the working electrode comprises a cation adsorbing/desorbing electrode, or an anion adsorbing/desorbing electrode.
65. The cell of any one of examples 61 to 64, wherein the working electrode comprises Prussian blue analogue electrodes, metal oxides electrodes, polymer-based electrodes, metal sulfide electrodes, metal phosphate electrodes, carbon-based electrodes, MXene electrodes, alloying-type electrodes, or a combination thereof.
66. The cell of any one of examples 61 to 65, for use as a battery.

In another example, the present disclosure generally provides:
67. A system configured to perform the method of any one of examples 1 to 60.
68. A system, comprising:
an electrochemical cell, the electrochemical cell configured for
   accepting a first aqueous solution comprising a first concentration of ions,
   electrochemically absorbing the ions from the first aqueous solution into an electrode of the electrochemical cell to form a second aqueous solution comprising a second concentration of the ions, the second concentration being less than the first concentration,
   discharging the second aqueous solution from the electrochemical cell;
   accepting a third aqueous solution comprising a third concentration of the ions;
   electrochemically desorbing the ions from the electrode of the electrochemical cell into the third aqueous solution to form a fourth aqueous solution comprising a fourth concentration of the ions, the fourth concentration being greater than the third concentration, and
   discharging the fourth aqueous solution from the electrochemical cell; and
a mass transport device coupled to the electrochemical cell for providing the first aqueous solution and/or the third aqueous solution, and discharging the second aqueous solution and/or the fourth aqueous solution.
69. The system of example 67 or 68, wherein the system is powered by renewable energy sources.
70. The system of example 68 or 69, or any one of examples 67 to 69, wherein the mass transport system comprises pumps and pipes in fluid communication with the electrochemical cell, for providing the first aqueous solution and/or the third aqueous solution to the electrochemical cell and discharging the second aqueous solution and/or the fourth aqueous solution from the electrochemical cell.
71. The system of any one of examples 68 to 70, or any one of examples 67 to 70, wherein the mass transport system comprises an autonomous submersible vehicle for positioning the electrochemical cell at a first distance from a surface water, and/or for positioning the electrochemical cell at a second distance from a surface water.
72. The system example 71, or any one of examples 67 to 71, wherein the first distance from the surface water is distal from the surface, and the second distance from the surface water is proximal to the surface; or the first distance from the surface water is proximal from the surface, and the second distance from the surface water is distal to the surface.
73. The system of example 71 or 72, or any one of examples 67 to 72, wherein the first distance or the second distance is proximal to an underwater seamount.
74. The system of any one of examples 68 to 73, or any one of examples 67 to 73, wherein the electrochemical cell comprises a galvanic cell, voltaic cell, an electrolytic cell, a fuel cell, a battery, or a combination thereof.
75. The system of any one of examples 68 to 74, or any one of examples 67 to 74, wherein the electrochemical cell comprises a counter electrode, the counter electrode comprising a gas-evolving electrode.
76. The system of any one of examples 68 to 75, or any one of examples 67 to 75, wherein the electrochemical cell comprises a counter electrode, the counter electrode comprising a hydrogen-storing electrode.
77. The system of example 76, or any one of examples 67 to 76, wherein the electrochemical cell is a battery.

### PEACH (Practical Electrochemical Air Capture) Methods and Systems.

Described herein are methods and systems for changing ion concentrations for forming inorganic carbon species. Described herein are methods and systems for changing ion concentrations in a waterbody. Described herein are methods and systems for carbon removal or capture. Described herein are methods and systems for changing ion concentrations in a surface water.

Described herein are methods and systems comprising processing water using electrochemical cells. In one or more examples of the methods and systems described herein, a first mass or aliquot of water is provided to an electrochemical cell. Ions in the water are adsorbed, intercalated, or inserted into an electrode of the cell, following which the ion-reduced water is replaced with a fresh mass or aliquot of water. The ions adsorbed, intercalated, or inserted into the electrode of the cell are then desorbed, stripped, or removed from the electrode and released into the fresh mass or aliquot of water, following which the ion-increased water is removed from the cell. If the ions are cations, then the cation-increased water removed from the cell may be contacted with a CO₂ source. Increasing cation concentrations in a waterbody may facilitate uptake or capture of CO₂ from a CO₂ source into the waterbody as inorganic carbon species, such as carbonate or bicarbonate ions. If the ions are anions, then the anion-reduced water removed from the cell may be contacted with a CO₂ source. Decreasing anion concentrations in a waterbody may facilitate uptake or capture of CO₂ from a CO₂ source and conversion into inorganic carbon species, such as carbonate or bicarbonate ions.

In one or more embodiments, the water described herein may include any water that comprises sufficient ion concentration to be suitable for use in the methods and systems described herein. The water described herein may include any water that comprises sufficient ion concentration for adsorption, intercalation, or insertion of said ions into an electrode of an electrochemical cell to form an ion-reduced water, which could then be used to facilitate capture or uptake of CO₂ into the water as inorganic carbon species, such as carbonate or bicarbonate ions. The water described herein may include any water that comprises sufficient ion concentration after ion-desorption from an electrode of an electrochemical cell to form an ion-increased water, which could then be used to facilitate capture or uptake of CO₂ into the water as inorganic carbon species, such as carbonate or bicarbonate ions.

In one or more embodiments, the water is also referred to as a waterbody. In one or more embodiments described herein, a “waterbody”—which is also referred to herein as a “water source”, “water mass or aliquot”, or “mass or aliquot of water”—may be any water, at any volume of said water, that includes sufficient ion concentration to be useful in the presently described methods or systems. In one or more embodiments described herein, a waterbody may include, but is not limited to, freshwater, brackish water, seawater, wastewater, produced water, recycled water, or subterranean water. In one or more embodiments, wastewater comprises wastewater from a desalination system. In one or more embodiments, produced water comprises production water from geothermal energy facilities, or oil and gas production facilities.

In one or more embodiments described herein, a waterbody may take the form of, but is not limited to surface or subterranean oceans, seas, lakes, ponds, wetlands, puddles, rivers, streams, canals, waterways, aquifers, reservoirs, or a combination thereof. A subterranean waterbody may otherwise be referred to herein as a “subterranean water”. In one or more embodiments described herein, a waterbody may have a surface water, intermediate water, and/or deep water as described herein.

In one or more embodiments described herein, “surface water”, also referred to herein as “near-surface water”, refers to a mass or aliquot of water having, or being proximal to a surface exhibiting surface tension at a gas-liquid interface; for example, having, or being proximal to a surface in contact with Earth's atmosphere or an applied flow of gas. In one or more embodiments described herein, in the context of a body of water, surface water refers to a water having a surface exhibiting surface tension at a gas-liquid interface and extending to a depth within 20 meters or less of said interface (e.g., the surface of the water). In one or more embodiments described herein, “deep water” refers to a mass or aliquot of water that does not have a surface exhibiting surface tension at a gas-liquid interface, and exists at a depth of 500 meters or more below a surface of a water (such as a surface exhibiting surface tension at a gas-liquid interface). In one or more embodiments described herein, “intermediate water” refers to a mass or aliquot of water that does not have a surface exhibiting surface tension at a gas-liquid interface, and exists at a depth between surface water and deep water, such as at a depth greater than surface water and at a depth less than deep water.

In one or more embodiments described herein, an “aqueous solution comprising a concentration of ions” as described herein may be sourced from a waterbody as described herein. In one or more embodiments described herein, there herein referred “first solution”, “second solution”, “third solution”, and/or “fourth solution” are aqueous solutions. In one or more embodiments described herein, “at a distance from surface water” refers herein to being at a position relative to, or distanced from surface water.

The CO₂ source described herein may include any source that comprises sufficient CO₂ concentrations to be suitable for use in the methods and systems described herein. The CO₂ source described herein may include any source that comprises sufficient CO₂ concentration to facilitate capture, uptake, and/or conversation of CO₂ as inorganic carbon species, such as carbonate or bicarbonate ions, into a mass or aliquot of water that is ion-increased or ion-reduced. The CO₂ source described herein may include a natural CO₂ source, an anthropogenic CO₂ source, or a combination thereof. Natural CO₂ sources may include Earth's atmosphere, or CO₂ released from natural phenomena, such as decomposition, combustion, eruption, digestion, etc. Anthropogenic CO₂ sources may include tanks of CO₂ gas, CO₂-comprising gas streams, CO₂ produced through industrial, commercial, agricultural, transportation, and/or manufacturing processes or activities, or a combination thereof. The CO₂ source may be contacted with the mass or aliquot of water that is ion-increased or ion-reduced via passive means or active means. The passive means may include exposing the water to the CO₂ source, and allowing the two to equilibrate; for example, leaving the water in contact with Earth's atmosphere, or in a container with a headspace comprising CO₂. The active means may include contacting the water with the CO₂ source, and allowing the two to mix together; for example, by sparging the water with a gas stream comprising CO₂, such as a stream of air or an exhaust stream from an industrial process. The CO₂ source may comprise a dissolved CO₂. In one or more embodiments, “dissolved CO₂” refers to CO₂ being dissolved in a waterbody. In one or more embodiments, “dissolved CO₂” refers to CO₂ being dissolved into an “aqueous solution comprising a concentration of ions”.

The electrochemical cell described herein may include any electrochemical cell suitable for use in the methods and systems described herein. The electrochemical cell described herein may be configured to perform the methods described herein. The electrochemical cell described herein may include any electrochemical cell capable of electrochemically adsorbing, intercalating, or inserting ions into an electrode of the electrochemical cell. The electrochemical cell described herein may include any electrochemical cell capable of electrochemically desorbing, removing, or stripping ions from an electrode of the electrochemical cell. The electrochemical cell may include a galvanic cell, a voltaic cell, an electrolytic cell, fuel cell, or a combination thereof. The electrochemical cell may be an electrolyzer. The electrochemical cell may be a battery.

The electrode of the electrochemical cell described herein may include any working electrode suitable for use in the methods and systems described herein. The electrode described herein may include any working electrode capable of electrochemically adsorbing, intercalating, or inserting ions into itself, such as into its lattice. The electrode described herein may include any working electrode capable of electrochemically desorbing, removing, or stripping and releasing ions from itself, such as from its lattice. The electrode described herein may comprise ion-selective electrode materials for extraction and expulsion of cations and anions, such as Ca, Na, and Cl ions, from and to water masses or aliquots, such as freshwaters, brackish waters, seawaters, wastewaters, produced waters, etc. The electrode may include, but is not limited to, Prussian blue analogue electrodes, metal oxides electrodes, polymer-based electrodes, metal sulfide electrodes, metal phosphate electrodes, carbon-based electrodes, MXene electrodes, alloying-type electrodes, intercalation electrodes, conversion electrodes, or a combination thereof. The counter electrode of the electrochemical cell described herein may be a gas-evolving electrode, or a hydrogen-storing electrode. Use of such a a gas-evolving electrode, or a hydrogen-storing electrode may result in the methods or systems described herein having lower energy costs and/or a reduction in gas handling facilities.

In one or more embodiments described herein, “absorbing ions into an electrode” refers to inserting, or intercalating the ions into the electrode. In one or more embodiments described herein, absorbing, inserting, or intercalating ions into an electrode” refers to absorbing, inserting, or intercalating the ions into the lattice of the electrode. In one or more embodiments described herein, “desorbing ions from an electrode” refers to stripping or removing the ions from the electrode. In one or more embodiments described herein, desorbing, stripping, or removing ions from an electrode” refers to desorbing, stripping, or removing the ions from the lattice of the electrode.

The methods and systems described herein may modify water chemistries. The methods and systems described herein may extract and provide cations and anions from and to water masses or aliquots—such as freshwater, brackish water, or seawater masses or aliquots; wastewater masses or aliquots; or produced water masses or aliquots—in an electrochemical cell or electrolyzer compartment. The cations may include alkali or alkaline earth metals such as sodium or calcium, and the anions may include halide or polyatomic anions such as chloride, for example as main components of seawater. The methods and systems described herein may modify seawater chemistries in near surface marine environments.

The methods and systems described herein may comprise cation or anion-cycling electrochemical cells with or without reference electrodes, and/or customized electrode compositions. In the methods and systems described herein, cations and anions may be extracted and provided to and from water masses or aliquots electrochemically, such as by using ion-selective electrodes. The methods and systems described herein may also comprise a hydrogen-producing electrolyser, a battery comprising one or more electrochemical cells, and/or a carbon capture system.

The methods and systems described herein may modify charge balance in a waterbody by extracting and providing alkali metal or alkaline earth metal cations and/or halide or polyatomic anions from and to the waterbody. The methods and systems described herein may modify charge balance in a water mass or aliquot sourced from freshwater, brackish water, seawater, wastewater, produced water, or a combination thereof, and/or water sourced from surface water, intermediate water, or deep water, by extracting and providing alkali metal or alkaline earth metal cations and/or halide or polyatomic anions from and to the water masses or aliquots. In one or more examples, the methods and systems described herein provide cations to surface water through a system that extracts said ions from deeper or more distal water and moves it into near-surface water. In one or more examples, the methods and systems described herein provide anions to deep water through a system that extracts said ions from surface or more proximal water and moves it into deeper water. Extracting and providing said cations and anions from and to water masses or aliquots may motivate partitioning of CO₂ from a CO₂ source, such as atmospheric CO₂, into the water by converting dissolved CO₂ into inorganic carbon species, such as carbonate or bicarbonate anions.

The methods and systems described herein may extract cations, such as sodium or calcium cations, from deep water locations (e.g., freshwaters, brackish waters, seawaters, etc.) and expel the cations back to surface water. By doing so, the chemistry of the surface water may be changed and affect an increased uptake of CO₂ (e.g., from the atmosphere) into the surface water as inorganic carbon species, such as carbonate or bicarbonate ions. The methods and systems described herein may extract anions, such a chloride, from surface water and expel the anions into deep water (e.g., freshwaters, brackish waters, seawaters, etc.), also affecting an increased uptake of CO₂ (e.g., from the atmosphere) into the surface water as inorganic carbon species, such as carbonate or bicarbonate ions.

In one or more examples of the methods and systems described herein, the methods and systems may provide further uptake of carbon dioxide into the water from a CO₂ source, such as the atmosphere, via selection of the type of electrochemical cell that is used, such as an electrolyser. The electrochemical cell may include a gas-evolving electrode. The gas-evolving electrode may evolve hydrogen and produce hydroxide ions. The electrochemical cell may be an electrolyzer designed to produce hydrogen and hydroxide ions during the electrochemical extraction of cations or anions. As hydroxide ions are produced by the electrochemical cell or electrolyzer, they can react with carbon dioxide dissolved in water to produce inorganic carbon species such as carbonate or bicarbonate ion, further promoting uptake of carbon dioxide into the water from a CO₂ source (e.g., from the atmosphere). The electrolyser may operate with any waterbody. The electrolyser may operate with freshwaters, brackish waters, seawaters, wastewaters, produced waters, or a combination thereof. The electrolyser may operate with desalinated freshwaters, brackish waters, seawaters, wastewaters, produced waters, or a combination thereof. The electrolyser may operate with seawater, or may operate with desalinated seawater to mitigate risk of chlorine production. Desalination is well developed and is inexpensive (for example, Khan et al, 2021). In one or more examples, the methods and systems described herein may minimize or avoid the addition of exogenous metal hydroxides into a water mass or aliquot to prompt uptake of carbon dioxide from the atmosphere. In one or more examples, the methods and systems described herein may minimize or avoid the addition of exogenous metal hydroxides into a surface water via a dispersal system such as a boat to prompt uptake of carbon dioxide from the atmosphere.

In one or more examples, the methods and systems described herein may further comprise an electrolyzer, to which any one or part of the first, second, third, and/or fourth solution may be provided to the electrolyzer for producing additional hydrogen gas and hydroxide anions. The coupling of the methods and systems described herein with an additional electrolyzer may provide even further uptake of carbon dioxide from the atmosphere, where hydroxide ions produced by the electrolyzer can react with carbon dioxide dissolved in water to produce inorganic carbon species, such as bicarbonate ion.

Coupling renewable energy systems, desalination systems, and electrolyzers may provide a direct route to hydrogen production as a potential revenue stream to support CO₂ removal or capture. A practical hydrogen+CO₂ air capture system, however, requires other components to provide alkalinity necessary to capture CO₂ from near surface seawater equilibrated with the atmosphere, and this may be provided via the ion extraction and delivery process described herein.

The methods and systems described herein may comprise dispersal systems, such as cation and anion dispersal systems, to modify water chemistries over large-scale areas. The methods and systems described herein may comprise dispersal systems, such as cation and anion dispersal systems, to modify near surface seawater chemistries over large-scale areas. In one or more embodiments, a large-scale area comprises an area measured over square meters. In one or more embodiments, a large-scale area comprises an area measured over square kilometers. In one or more embodiments, a large-scale area comprises one, continuous area. In one or more embodiments, a large-scale area is comprised of two or more smaller-scale areas, where smaller-scale areas are smaller in area than large-scale areas.

The methods and systems described herein may comprise dispersal systems, such as cation and anion dispersal systems, to move and modify the chemistry of large volumes of water. The methods and systems described herein may comprise dispersal systems, such as cation and anion dispersal systems, to move and modify the chemistry of large volumes of near surface seawater. In one or more embodiments, a large volume comprises a volume measured over liters, barrels, or cubic meters. In one or more embodiments, a large volume comprises a volume of millions or billions of liters, barrels, or cubic meters. A cubic meter is about 6.29 barrels (unit). A barrel (unit) is about 42 gallons, which is about 159 liters.

The methods and systems described herein may also comprise water movement control processes. In one or more embodiments, water movement control processes comprise passive or active pumping systems, and associated piping and control systems. The methods and systems described herein may also comprise devices and supporting infrastructure for moving waterbodies, such as freshwater, brackish water, seawater, wastewater, produced water, recycled water, subterranean water, or a combination thereof, from different locations and/or depths. For example, electrochemical ion extraction, storage, and delivery systems may be mounted in autonomous submersible vehicles (ASVs) with self-contained power systems. These ASVs may extract ions from one portion of water, move to a different location and/or depth, and release the ions. The submersible vehicle may recharge its batteries and power systems by docking with a renewable electricity power system at the surface. The methods and systems described herein may also comprise pump and pipe systems for transporting and/or dispersing masses or aliquots of water to and from different devices (e.g., electrochemical cells), different locations, and/or different depths (e.g., between deep water and surface water; between subterranean and terranean surfaces; etc.).

In one or more examples of the methods and systems described herein, migration of cations from deep water environments to near-surface water may be achieved by a variety of routes, including but not limited to: 1) electrode-mitigated extraction of cations from deeper portions of water such as freshwaters, brackish waters, seawaters, etc., then subsequent expulsion of the cations into a water that is pumped to a surface water environment and released; or 2) electrode-mitigated extraction of cations from water in a deep water setting, such as freshwaters, brackish waters, seawaters, etc., using an electrode system housed in a submersible vehicle/device, otherwise referred to as an underwater autonomous vehicle (UAV) or autonomous underwater vehicle (AUV), that moves to shallower depths and releases the cation-enriched solution in a surface water environment. In one or more examples of the methods and systems described herein, dispersal systems at the surface water may include pumps and pipe systems for transport of the specific cation-enriched solution, such as to ship tanks whereby the cation-enriched solutions may be released over large areas during water or marine traffic activities. In one or more examples of the methods and systems described herein, migration of anions from a surface water to deep water environments may be achieved by a variety of routes, including but not limited to: 1) electrode-mitigated extraction of anions from surface water, then subsequent expulsion of the anions into a water that is pumped to the deeper water environment and released; or 2) electrode-mitigated extraction of anions from a surface water using an electrode system is housed in a submersible vehicle/device, that submerges and releases the anion-enriched solution to the deeper water environment.

In one or more examples of the methods and systems described herein, coupling an ion-delivery system, such as those described above, to an electrolyzer may more effectively provide ions(for example cations), to an electrolyzer electrode compartment than through provision of solid carbonate or silicate minerals (such as calcite in limestone), as described by Rau. No terrestrial mining activity would be needed to provide ions, for example cations, to an electrolyzer—only moving waterbodies, such as freshwater, brackish water, seawater, wastewater, produced water, recycled water, subterranean water, or a combination thereof. In addition to an active pump dispersal system, an alternate configuration to disburse ion-modified water compositions, such as ion-modified freshwater, brackish water, seawater, wastewater, recycled water, subterranean water, or produced water compositions, at the surface may include use of tanks on board ships. Ships could fill up with ion-modified water at offshore facilities and, during their normal marine traffic activities, slowly disburse ion-modified water to the near surface environment using metered chemical delivery pumps.

In one or more examples of a system as described herein, the system is powered by offshore wind, wave motion, and photovoltaic electricity, or other low carbon energy systems. In one or more examples, the system is part of, or coupled to a marine platform. In one or more examples, the system is part of, or coupled to a marine platform that comprises other systems or facilities, such as marine aquaculture, residential facilities, and/or facilities related to marine shipping support including hydrogen or ammonia fuelling facilities.

Modification of water chemistry to promote carbon dioxide uptake as inorganic carbon species.

The following describes modification of surface seawater chemistry to promote carbon dioxide uptake from the atmosphere as carbonate or bicarbonate ion, but is considered to generally apply to other water masses or aliquots and/or other CO₂ sources as described herein.

Water environments, such as freshwaters, brackish waters, seawaters, wastewaters, produced waters, recycled water, subterranean water, or a combination thereof, in contact with the atmosphere can achieve a predictable quasi-equilibrium where the total concentration of inorganic CO₂ in the water (e.g., seawater) will be a function of the balance between positive and negative ions in the water (e.g., seawater) solution and the partial pressure of CO₂ (p_{CO}_{₂}) in the atmosphere (Stumm and Morgan, 1996; Halevy and Bachan, 2017).

Charge balance in seawater may be approximated as:

$$[ {HCO}_{3}^{-} ] + 2 [ {CO}_{3}^{2 -} ] + [ {OH}^{-} ] - [ {H}^{+} ] = [ {Na}^{+} ] - [ {Cl}^{-} ] + [ {K}^{+} ] + 2 [ {Mg}^{2 +} ] + 2 [ {Ca}^{2 +} ] - 2 [ {SO}_{4}^{2 -} ] , \qquad ( 1 )$$

where the equation has been arranged such that the left hand side represents the total concentration of inorganic carbon species (HCO₃⁻ and CO₃²⁻) in solution and the dissociation products of water (OH⁻ and H⁺) and the right hand side represents the concentration of all other major (concentration >1 mmol/kg) cations and ions in solution (cf. Halevy and Bachan, 2017).

Using the basic principles of aqueous geochemistry, the concentration of [OH⁻] may be calculated according to:

$$[ {OH}^{-} ] = \frac{{K}_{w}}{[ {H}^{+} ]} \qquad ( 2 )$$

where K_{W} is the stoichiometric equilibrium constant for water dissociation in seawater, and the concentrations of HCO₃⁻ and CO₃⁻ may be calculated according to:

$$[ {HCO}_{3}^{-} ] = {p}_{{CO}_{2}} \times {K}_{H} \times \frac{{K}_{{a}_{1}}}{[ {H}^{+} ]} \qquad ( 3 )$$

$$and$$

$$[ {CO}_{3}^{2 -} ] = {p}_{{CO}_{2}} \times {K}_{H} \times \frac{{K}_{{a}_{1}}}{[ {H}^{+} ]} \times \frac{{K}_{a 2}}{{[ {H}^{+} ]}^{2}} , \qquad ( 4 )$$

respectively, where Kₐ_{₁} and Kₐ_{₂} are the stoichiometric dissociation constants for carbonic acid and K_{H} is the Henry's law constant for CO₂ dissolution into seawater. Equations 2-4 may be substituted for the variables on the left hand side of Equation 1, such that the total amount of inorganic carbon dissolved in seawater is a function of pCO₂ and the concentrations of ions on the right hand side of Equation 1. Thus, given a value of p_{CO}_{₂}(e.g., the current concentration of CO₂ in the atmosphere) and the concentrations of ions on the right hand side of Equation 1, one may iteratively solve for the total amount of inorganic carbon in seawater.

It was thus determined that adjustments in the concentrations of ions on the right hand side of Equation 1 at constant p_{CO}_{₂} could change the total amount of carbon in solution. For example, increasing the concentration of any positively charged species (Na⁺, Ca²⁺, Mg²⁺ or K⁺) or decreasing the concentration of any negatively charged species (Cl⁻ or SO₄²⁻) may increase the concentration of inorganic carbon species (HCO₃⁻ and CO₃²⁻) in waters, such as freshwaters, brackish waters, seawaters, wastewaters, produced waters, recycled water, subterranean water, or a combination thereof, at equilibrium with the atmosphere, which may offer an efficient means for increasing uptake of CO₂ into water as inorganic carbon species, such as carbonate or bicarbonate ions.

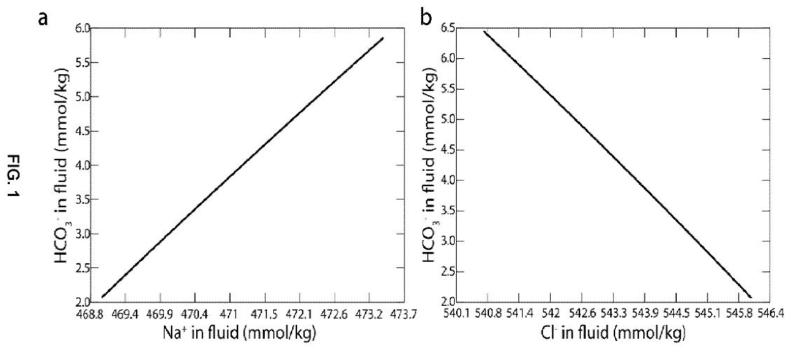

For example, geochemical modelling and experiment indicated that changing the charge balance in near surface seawater by cation addition or anion removal promoted CO₂ uptake to seawater bicarbonate. Seawaters are “open” with respect to the atmosphere, with charge balance being maintained by absorbing CO₂ from the atmosphere. For example, FIG. 1 depicts the results of geochemical thermodynamic modelling calculations (performed using Geochemists Work Bench software) which show that even small (e.g. 1% of the total) changes in, for example, Na⁺ or Cl⁻ ion concentrations in surface seawater in contact with the atmosphere, can double or triple the carbon content of the seawater, as represented by bicarbonate ion. Such calculations suggest that routes to promote sequestration of CO₂ as inorganic carbon species, such as bicarbonate ion include increasing surface water cation content (e.g., Na⁺, Ca²⁺), or reducing surface water anion content (e.g., Cl⁻). Further, without wishing to be bound by theory, small changes in ion concentration are not expected to profoundly negatively impact marine biota, aquatic life, etc.

In one or more embodiments of the methods and systems described herein, the methods and systems are implemented in view of water circulation models, such as ocean circulation, and carbon pool mixing models to achieve sufficient distributions of cations and thus sufficient sequestration of carbon species.

### Modifying Cation Concentration in a Water

The following describes modifying cation concentration in a water using sodium ion concentration in surface water, such as seawater, as an example, but is considered to generally apply to other cations and/or other water masses or aliquots as described herein.

Typically, water such as freshwaters, brackish waters, seawaters, wastewaters, produced waters, recycled water, subterranean water, or a combination thereof comprises varying concentrations of ions, including sodium (e.g., 10.78 g/kg), calcium (e.g., 0.41 g/kg), potassium (e.g., 0.39 g/kg), magnesium (e.g., 1.28 g/kg) and chloride (e.g., 19.35 g/kg) (Pilson, 2012). Cations such as sodium and calcium can be separated from water, such as freshwaters, brackish waters, seawaters, wastewaters, produced waters, recycled water, subterranean water, or a combination thereof, by intercalating the cations in materials that can selectively intercalate ions at different electrochemical potentials, such as a battery electrode. For example, for sodium extraction from water such as seawater, materials like FePO₄ (Wang et al., 2018), NaFePO₄ (Saurel et al., 2015), Na₃V₂(PO₄)₃(Song et al., 2014), Na₂V₆O₁₆ (Deng et al., 2014), Na_{0.5}Mn_{0.5}Ti_{0.5}O₂ (Zhang et al., 2017) may be used.

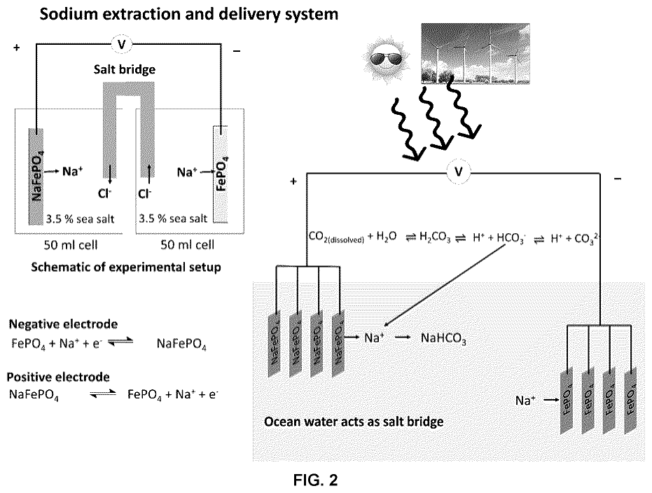

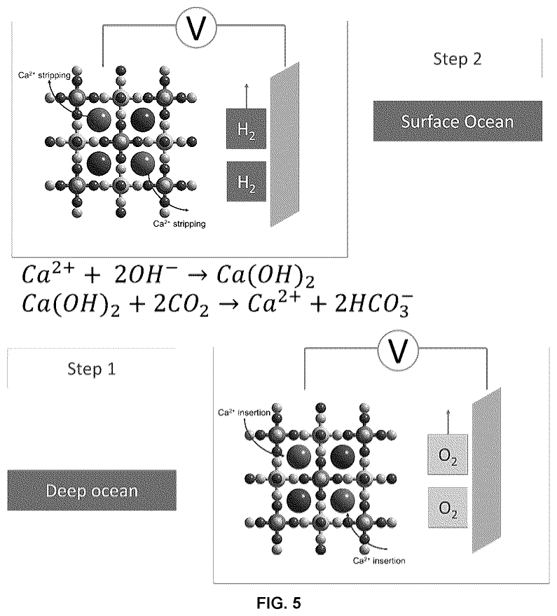

Described herein are three electrode systems, with a reference electrode for lab scale controlled experiment purposes, and dual-single (two-electrode system) electrode systems for cation/anion removal and addition to water, such as seawater (e.g., see FIG. 5, 17, 18, 19). For example, in respect of Example 2 (Na⁺ ion manipulation; see below), a three electrode system was used, including a working electrode of NaFePO₄, a counter electrode of graphite, and a reference electrode of Ag/AgCl (sat KCl) and observed to be effective at extracting and delivering sodium ions from a mass of seawater depending on polarities in the cell. Another electrode system that may be used in the methods and systems described herein includes dual-single electrodes linked through a conductive bridge, such as a chloride bridge. This dual single electrode approach is illustrated in FIG. 2, and was used both in a laboratory configuration and in a practical configuration whereby seawater was used as a conductive bridge element. During operation, with one polarity, sodium was discharged from one electrode and accumulated in the other. Following movements of seawater, the cell was reversed and sodium was added to a mass of native seawater to raise sodium ion concentration. Experiments in the laboratory have demonstrated the effectiveness of using iron phosphate electrodes, linked through a chloride bridge, to modify the ion composition of water, such as seawater. Other experiments in the laboratory have also demonstrated the effectiveness of using an electrochemical cell comprising no salt bridge, or comprising any separation between the electrodes; for example, using seawater as a salt bridge, as shown in FIG. 2. Using materials such as those described above, electrode systems may be constructed to extract sodium from deep water environments, such as deep seawaters, and return it to a surface water, such as a native seawater phase, to increase sodium concentration locally; and that parcel of modified seawater may be distributed at the ocean surface to enhance CO₂ uptake. This may involve coupling an ion selective electrode system such as that described, to a device or system able to provide seawater to the electrode, permit ion extraction electrochemically, provide a fresh seawater sample to the electrode, permit the electrode to discharge the stored ions to the new seawater sample and then transport the ion enriched seawater sample to the near surface environment.

### Modifying Chloride Ion Concentration in a Water

The following describes modifying anion concentration in a water using chloride ion concentration in seawater as an example, but is considered to generally apply to other anions and/or other water masses or aliquots as described herein.

As described above, water such as freshwaters, brackish waters, seawaters, wastewaters, produced waters, recycled water, subterranean water, or a combination thereof comprises varying concentrations of ions, including, in seawater, sodium (e.g., 10.78 g/kg), calcium (e.g., 0.41 g/kg), potassium (e.g., 0.39 g/kg), magnesium (e.g., 1.28 g/kg) and chloride (e.g., 19.35 g/kg) (Pilson, 2012). Anions such as chloride can be separated from water, such as freshwaters, brackish waters, seawaters, wastewaters, produced waters, recycled water, subterranean water, or a combination thereof, by intercalating the anions in materials that can selectively intercalate ions at different electrochemical potentials, such as a battery electrode. For example, for chloride extraction from water such as seawater, bismuth and silver may be used to selectively remove chloride ions (Chang et al., 2020) (Pasta et al., 2012). Bismuth may be used in the form of bismuth oxychloride (BiOCl), silver may be used in the form of silver chloride (AgCl), and the reversible electrochemistry of these materials may be used for chloride removal from and replacement to water, such as seawater. Polypyrrole systems for chloride ion extraction have also been described (Kong et al, 2019).

Three electrode systems may involve a working electrode of Ag or polypyrrole, a counter electrode of graphite and a reference electrode of Ag/AgCl (sat KCl). A dual-single two electrode system using silver electrodes coupled through a salt bridge or seawater, similar to the system described in FIGS. 2, 17-19, may facilitate removal and addition of chloride ion to seawater. Using these materials, electrode systems can be constructed to extract chloride ions from a surface water to enhance CO₂ uptake and subsequently return the chloride to a fresh water phase that can be distributed into deeper waters, such as the deep ocean. Decreasing chloride concentration in surface water, such as seawater, may involve coupling an ion selective electrode system to a device or system able to provide surface water to the electrode, permit ion extraction electrochemically thereby lowering the chloride concentration of the surface water, then provide a new water sample to the electrode, permit the electrode to discharge the stored chloride to the new water sample and then transport the chloride-enriched water sample to a deeper ocean environment.

### Systems and Methods for Modifying Ion Concentration in a Water

The following describes modifying ion concentration in a water using selective extraction of sodium and/or calcium ions from, and delivery of sodium and calcium ions to, surface, intermediate, and deep seawater as an example, but is considered to generally apply to other ions and/or other water masses or aliquots as described herein.

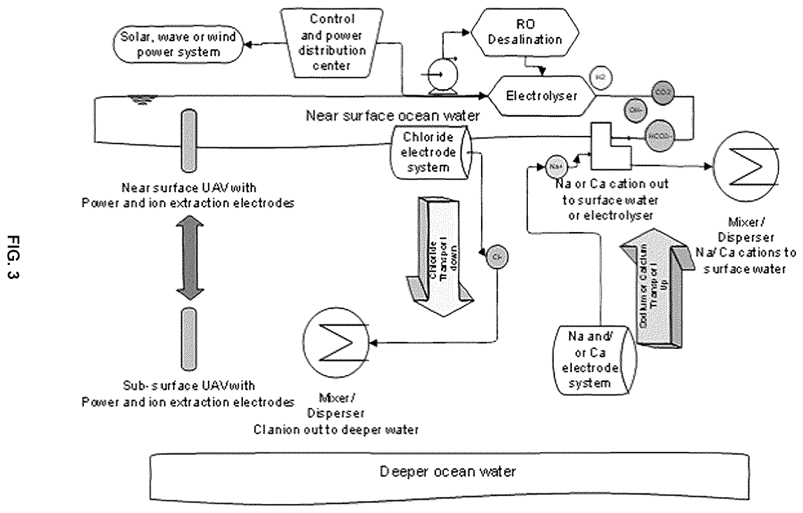

In one or more examples of the methods and systems described herein, the selective extraction of sodium and/or calcium ions from, and delivery of sodium and calcium ions to, seawater using an electrode system is described with reference to FIG. 3-5.

FIG. 3 depicts an example of a configuration of an overall carbon dioxide removal or carbon capture system. In this example, at the ocean surface, there is a renewable energy supply and control system that supports a water electrolyzer running on desalinated water to produce hydrogen and hydroxide ions. At the ocean subsurface, the anion and/or cation chemistry of the surface ocean water is modified using various ion-selective electrodes, either physically mounted in a permanent configuration or present in submersibles, such as autonomous submersibles capable of moving vertically into different water masses at different water depths. The ion-selective electrodes are coupled through tubes, and water movement is empowered by either actively powered pumps or through systems depending on wave motion. In operation, the ion-selective electrode systems extracts sodium ions from the seawater which are migrated to the near surface water. Conversely, the ion-selective electrode systems extract chloride ions from the near surface waters and migrate them in modified seawater to a deeper ocean water environment. Pumps and pipes are used to disperse the migrated and modified chemistry ocean waters to their target depths or to the electrolyzer as described in FIG. 3. The system as exemplified, may not use the electrolyzer, but the benefit is that hydrogen fuel gas is an additional saleable product—and as described above, can contribute to the overall CO₂ removal performance.

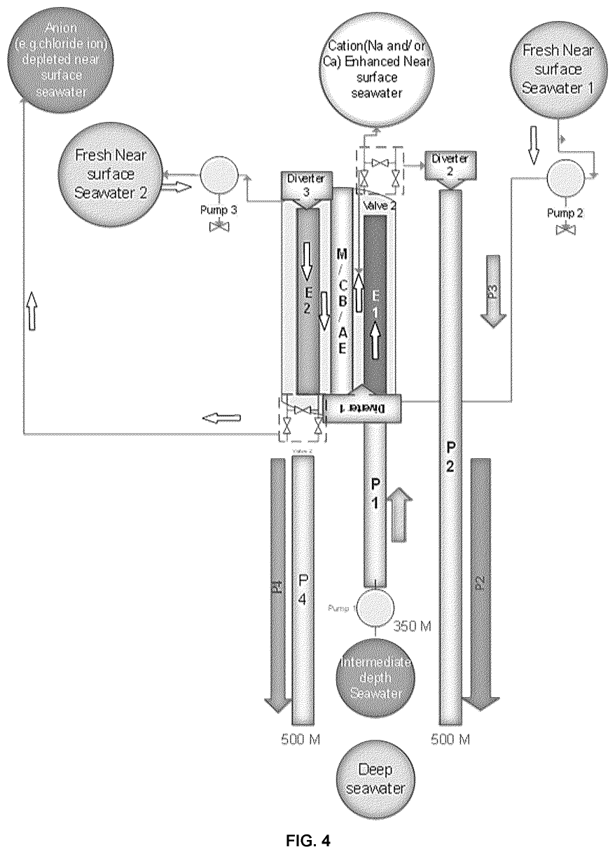

FIG. 4 depicts an example of an assembly of ion-selective electrodes and corresponding flow paths. For example, the assembly includes single or dual electrode systems (E1 or E2), to extract or deliver cations (Na⁺, Ca²⁺) or anions (Cl⁻) from and to seawater either near the surface, at intermediate depths (ca. 350 m), or at greater depths (>500 m). The ion selective electrodes could be replaced by any device that can selectively remove and then return specific ions from an aqueous solution, including membrane- and osmosis-based systems. Electrochemical cells can be isolated or linked through a conductive bridge, membrane or auxiliary electrodes (Venkatesan et al., 2021). Water can be moved between intermediate depths, near surface waters and deep water masses (>500 m) by active or passive pumping means through a variety of pipes, diverters and valves. Depicted in FIG. 4 is an exemplary operation of a sodium and a chloride ion mobilization system. To promote carbon dioxide uptake in near surface marine waters, step one involves flow of seawater from intermediate depths up through pipe P1 and past the sodium ion selective electrodes E1 where sodium ions are extracted from the seawater, modified seawater being expelled from the device through more valves and diverters to pipe P2. After an appropriate time, flow is stopped and valves reconfigured such that when fresh near surface seawater is charged through the device by pump 2 and pipe P3, and with the polarity of the sodium selective electrode reversed, sodium ions are now added to the seawater and discharged near the surface or to the electrolyzer resulting in atmospheric CO₂ uptake as bicarbonate. At the same time, or separately, depletion of chloride ion in the surface water can be promoted by the device. To promote chloride ion depletion, near surface seawater is moved by pump 3 and diverter 3 past a chloride selective electrode E2 which extracts chloride ion, the excess water being disposed of by circulation back to the near surface water. After an appropriate time, the polarity of the chloride extraction electrode is reversed and flow of water past the chloride electrode E2 is motivated by pump 1, pipe P1, diverter 1, and other associated valves, with water from intermediate depth flowing past electrode E2 which is now discharging its chloride ions, which are disposed of at a depth where remixing of the water mass to the surface would be greater than a century (>500 m) through pipe P4.

FIG. 5 depicts an exemplary electrochemical setup to move a calcium ion-water stream from deep waters, such as the deep ocean; to a water stream at the surface (see Example 1). With reference to FIG. 5, the depicted ion-selective electrode functions to change surface water chemistry in the following manner. In a deeper portion of seawater, the electrode system inserts, for example, calcium ions into a storage electrode. After extracting calcium from the water into the electrode, the polarity of the system is reversed and calcium ions are stripped from the electrode back into the surrounding electrolyte, which can be a seawater sample provided from any depth. Pumps or other systems transfer this calcium enriched electrolyte to surface water, or to an electrolyzer compartment as described with reference to FIGS. 3 and 4.

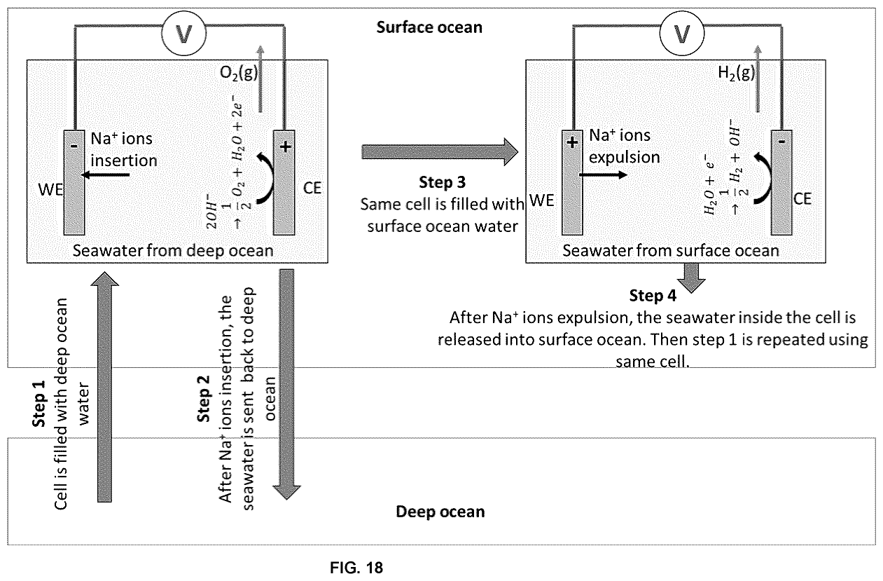

FIG. 18 depicts an exemplary electrochemical setup to move a sodium ion-water stream from deep water, such as the deep ocean, to surface water, such as surface ocean water. With reference to FIG. 18, the depicted ion-selective electrode functions to change water chemistry in the following manner. An electrochemical cell is provided, the cell comprising ion insertion/expulsion electrodes, such as Na⁺ or Ca²⁺ selective electrodes (WE: working electrodes) and inert electrodes, such as Pt or graphite as gas-evolution electrodes CE: counter electrode). In step 1 of FIG. 18, the electrochemical cell is filled with deep ocean water and Na⁺ ions are inserted into the electrode. In step 2, the cell is emptied and the deep ocean water inside the cell is sent back to the deep ocean. In step 3, the same cell is filled with surface ocean water, and the Na⁺ ions are expelled into that water. In step 4, the increased-Na⁺ water in the cell is released into surface ocean water, which can facilitate capture of atmospheric CO₂ into the surface water as inorganic carbon species, such as carbonate or bicarbonate ions. Additionally, the gas-evolution electrode of the electrochemical cell may produce hydrogen gas and hydroxide anions, which may also facilitate further uptake of carbon dioxide from the atmosphere, as the hydroxide ions produced at the gas-evolution electrode can also react with the atmospheric carbon dioxide that becomes dissolved in the surface water to produce additional inorganic carbon species, such as carbonate or bicarbonate ions.

In one or more examples of the methods and systems described herein, the quantity of bicarbonate in seawater was found to be many orders of magnitude larger than any amount of bicarbonate that may be added into surface waters on a century timescale through the methods and systems described herein. For example, Lee et al. (2019) suggested that the Total Carbon in seawater is dominated by bicarbonate and combines: 900 Gton Carbon (Surface Ocean)+37,100 Gton carbon (Intermediate and Deep Ocean). The methods and systems described herein may securely store a carbon budget on the order of around a 1 Gt/year or more; and so over a century, may store 100 Gton C, which is about 2 orders of magnitude less than the 38,000 Gton carbon reservoir in the whole ocean. As such, without wishing to be bound by theory, the methods and systems described herein may capture carbon in the form of bicarbonate without substantially perturbing an important existing carbon reservoir.

Without wishing to be bound by theory, it is considered that the herein described methods and systems may be effective and safe in sense that they should not perturb the large natural carbon storage reservoir in a substantial way.

In one or more examples of the methods and systems described herein, implementation of the methods and systems may further comprise seamounts. In many oceanic settings, hydrothermally driven circulation systems are set up between large and small seamounts. These seamounts tend to be hydraulically connected through basaltic aquifers in the oceanic crust (Winslow et al, 2016; Lauer et al, 2018). These natural systems set up substantial circulation of seawater, with intakes to the circulatory system associated with larger seamounts and discharges of warmed water that have been processed through a basaltic aquifer coming from the hydraulically linked small seamounts. Without wishing to be bound by theory, such seamount systems may be useful natural circulatory systems for providing or disposing of waters enriched in or depleted of various cations and anions. For example, waters naturally circulating from the ocean into large seamounts may provide a useful site to dispose of waters removed from the surface that contain substantial concentrations of anions, or to provide useful potential sites to dispose of waters of low pH derived from any electrochemical process near the surface waters. Further, waters emanating from the small seamounts of hydrothermal systems will likely have been processed for substantial time periods through a reactive basaltic aquifer, which may have removed CO₂ or carbonate ions from the seawater. These processed waters may provide a cation-containing water supply that can be provided to the surface ocean environments where cations such as sodium ion can be added to increase surface water alkalinity and CO₂ uptake through the methods and systems described herein. Thus, the methods and systems described herein may involve delivery of chloride enriched waters to large seamounts through well delivery systems; and/or provision of carbonate-depleted waters for sodium-ion enrichment and subsequent provision to the near surface waters from well completions in small oceanic seamounts.

Exemplary large-scale system process design and operation to change water chemistry and potentially provide ion balance to a hydrogen producing electrolyzer system.

The following describes large-scale system process designs and operations to change near surface water chemistry and potentially provide ion balance to a hydrogen producing electrolyzer system using sodium and/or calcium ions in seawater as an example, but is considered to generally apply to other systems, electrochemical cells, electrodes, ions, and/or other water masses or aliquots as described herein.

As described herein, ion-selective electrodes may operate within a large-scale system as depicted in FIGS. 3 and 4. In one exemplary design, there are power systems and controls at the sea surface. Further, there is an optional hydrogen-producing water electrolyzer system that is optionally coupled to a desalination device, such as a reverse osmosis system to facilitate increased electrolyzer efficiency and eliminate production of unwanted chlorine gas. Ions are extracted and delivered from and to seawater by electrochemical ion extraction and delivery devices including capacitive deionization systems, desalination batteries, desalination generators, or ion-selective electrodes as described above. After ions are electrochemically extracted from either deeper or near surface seawater into an ion-selective electrode, they are then expelled from the electrode into a new aliquot of seawater and that seawater aliquot is pumped either to surface water or to deeper water depending on whether the concentration of cations is being modified (e.g., by migrating cation rich water to the near surface water), or concentration of anions is being modified (e.g., by migrating anion rich fluids from surface water to deeper water). This is facilitated by a system of pumps and pipes. In another exemplary design, electrochemical ion extraction, storage, and delivery systems are mounted in autonomous submersible vehicles with self-contained power systems. These ASVs may extract ions from one portion of seawater, move to a different seawater depth, and release the ions. The submersible vehicle may recharge its batteries and power systems by docking with a renewable electricity power system at the surface.

As described above, FIG. 3 depicts an example of a near ocean surface system for producing hydrogen and bicarbonate ion as a secure carbon store, near the surface of the ocean. The system may be powered by offshore wind, wave, and photovoltaic electricity likely on a marine platform. The electrolyser may operate with seawater or may operate with desalinated seawater to mitigate risk of chlorine production. Desalination is well developed and costs less that 1$/ton of seawater to desalinate. A combination of renewable energy systems, desalination systems, and electrolyzers may provide a complementary route to hydrogen production. Linked to the ion-modification methods and systems, such a system may provides both hydrogen as a revenue source and alkalinity to further promote CO₂ uptake.

Exemplary carbon removal or capture related to geothermal energy recovery, petroleum production, or other water recycling systems.

In one or more examples of the methods and systems described herein, the methods or systems may be useful for modifying ion concentrations in a mass or aliquot of water and/or useful for carbon capture, such as atmospheric carbon dioxide sequestration as inorganic carbon species, in a large body of water such as an ocean setting. The methods and systems described herein may extract ions from one water mass or aliquot and migrate them to another water mass or aliquot, producing an ion-modified water mass or aliquot that can promote uptake of carbon dioxide from any CO₂ source in contact with the ion-modified water, transforming the carbon dioxide to inorganic carbon species, such as carbonate or bicarbonate ions. This may capture the carbon dioxide in a form that facilitates its sequestration in water masses, such as the ocean or large lakes, or in subterranean reservoirs via wells.

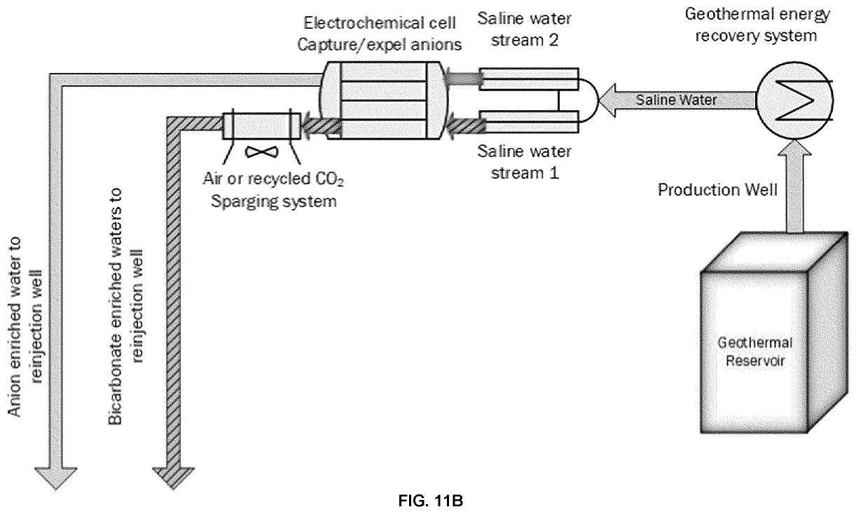

In one or more examples of the methods and systems described herein, the methods or systems may be useful for modifying ion concentrations in a mass or aliquot of water and/or useful for carbon capture in any environment where water is being moved and/or where waters of different ion concentrations are present and accessible. In one or more examples, the methods and systems described herein may be applied to water recycling systems. In one or more examples, the methods and systems described herein may be applied to subterranean water recycling systems, such as geothermal energy recovery systems, or petroleum production. In one or more examples, the methods and systems described herein may be applied to cooled and degassed waters from such water recycling systems. In at least some examples of subterranean water recycling systems, such as geothermal energy recovery systems, or petroleum production, they recover saline waters, and recycle very large volumes of water from subterranean depths to the surface and then back into subterranean depths (for example, via drilled wells, injection wells, etc.). FIGS. 11A and B depicts an example of the methods and systems described herein applied to a geothermal energy recovery system, though it is considered to generally apply to other water recycling systems.

With reference to FIGS. 11A and B, saline fluids from a geothermal reservoir are pumped from the subterranean reservoir to an electrochemical cell. The saline fluid is provided to the cell split into two streams that are processed to produce a stream enriched with inorganic carbon species (e.g., HCO₃⁻ and CO₃²⁻) and a stream depleted of ions. In one or more examples, the enriched stream and depleted stream may be stored separately. In one or more examples, the enriched stream and depleted stream may be stored together in a subsurface reservoir. In one or more examples, one or more of the streams may be stored in a surface reservoir, such as a settling pond, a wastewater treatment facility, a lake, a sea, an ocean, etc.; or a subterranean reservoir, such as geothermal reservoirs, drilled wells, oil and gas wells, etc. In the example illustrated in FIG. 11A, cooled and degassed water from a geothermal reservoir is split, with one stream used as a source of cations, the other stream then having these cations added to it to facilitate capture of carbon dioxide. Generally, the process involves: STEP1: Electrochemical cell charging with water stream 1; STEP 2: Electrochemical insertion of cations into electrodes from stream 1 to form a cation-reduced water; STEP 3: discharging the cation-reduced water into a reinjection system or well; STEP 4: Electrochemical cell charging with water stream 2; STEP 5: Electrochemically expel cations into water stream 2 while equilibrating with air or recycled carbon dioxide via a sparging system to form carbonate/bicarbonate-enriched waters; STEP 6: Discharging carbonate/bicarbonate enriched waters to a reinjection system or well. In the example illustrated in FIG. 11B, cooled and degassed water from a geothermal reservoir is split, with one stream used as a source of anions, the other stream then having these anions removed from it to facilitate capture of carbon dioxide. Generally, the process involves: STEP1: Electrochemical cell charging with water stream 1; STEP 2: Electrochemical insertion of anions into electrodes from stream 1 to form a anion-reduced water; STEP 3: discharging the anion-reduced water from the electrochemical cell and equilibrating with air or recycled carbon dioxide via a sparging system to form carbonate/bicarbonate-enriched waters; STEP 4: Discharging the carbonate/bicarbonate enriched waters to a reinjection system or well; STEP 5: Electrochemical cell charging with water stream 2; STEP 6: Electrochemically expel anions from electrodes into water stream 2 to regenerate the electrode and form anion-enriched water; STEP 6: Discharging carbonate/bicarbonate enriched waters to a reinjection system or well.

In one or more examples of the methods and systems described herein, the methods or systems may be a useful addition to any system that involves ion-comprising water circulation and disposal, such as wastewater streams from reverse osmosis desalination systems, to facilitate uptake of CO₂; for example, for disposal as an inorganic carbon species in a surface or subsurface setting. In one or more examples of the methods and systems described herein, when the ion-increased or ion-reduced water is discharged into highly reactive rock media such as basalt, mineral carbonation may result, which may result in even more strongly secure sequestered carbon.

In one or more examples of the methods and systems described herein, the methods or systems may be useful in petroleum production. In an oil and gas production setting, a production well generally produces a mixture of oil, gas, and water having a high ion concentration (e.g., saline water), and potentially associated solids, such as sand, etc. Oil, gas and any produced solids may be separated from the water using a separator, and said water may then be recycled for disposal to a subsurface reservoir. Said reservoir may be the production well from which the oil, gas, water, and solids were originally produced; or, said reservoir could be a different reservoir. The methods and systems described herein may be applied to such a production setting by providing the separated, production well water to an electrochemical cell. Ions in said water, such as sodium ions, may then be adsorbed or inserted into an electrode of the cell, forming an ion-reduced well water that may be diverted to waste remediation, disposal, or storage, for example in a surface or subsurface reservoir. The electrochemical cell may then be filled with fresh production well water, following which the ions may be expelled from the electrodes into the water to form an ion-increased water. The ion-increased water may be diverted to a sparging device and mixed with either air or a CO₂ enriched gas (e.g., from the separator gas), promoting uptake of CO₂ and conversion to inorganic carbon species, such as carbonate or bicarbonate ion. The resultant carbon-enriched water stream may then be diverted to waste remediation, disposal, or storage, for example in a surface or subsurface reservoir. In one or more examples of the methods and systems described herein, the water stream splitting approach described in FIGS. 11A and B may also be applied in oil and gas production settings. In addition, for example, in many petroleum basins, oil and gas production takes place from several different reservoirs in stratigraphic superposition, invariably with coproduction of ion-comprising waters, such as saline waters of variable ion concentration or salinity. In the Western Canada sedimentary basin, there are multiple locations where oil, gas, and water with relatively low salinities are produced from relatively shallow (less than 1-2 km) Cretaceous age reservoirs (e.g. Cretaceous Manville formation reservoirs)—while nearby, much more saline waters are produced from deeper Devonian aged reservoirs, which contain water with very high ion concentrations, or very high salinity waters, sometimes with concentrations up to the ion's saturation point (e.g., with waters in contact with minerals such as halite (NaCl)). In one or more examples, the methods and systems described herein may be used to extract ions, such as cations, from high-salinity Devonian reservoir waters; expel or discharge those ions into a fresher water that is then diverted to an air/CO₂ sparging system, such as depicted in FIGS. 11A and B, and 12 for processing oil and gas production waters from shallower, lower salinity waters of the Cretaceous reservoirs. This may promote CO₂ capture as an inorganic carbon species, such as bicarbonate, in the ion-increased water, which may then be stored or disposed of in a subterranean reservoir, such as a reinjection well.

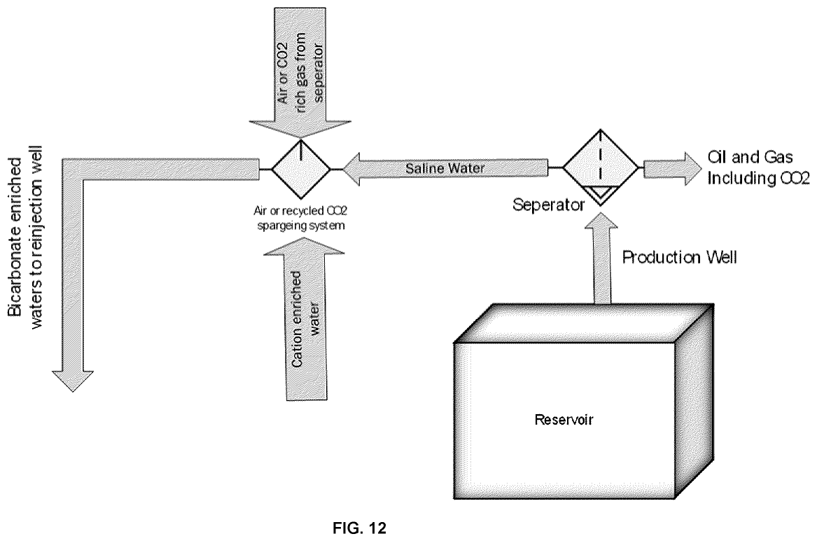

FIG. 12 depicts an example of the methods and systems described herein applied in an oil and gas production setting. FIG. 12 depicts a production well that produces oil, gas and water, and diverts it to a separator that separates the water from the oil, gas, solids, etc. As depicted, said water stream then passes to a sparging system connected to a stream of cation-enriched water from a PEACH electrochemical system, and to air or other CO₂ enriched gas (e.g., from the production separator). The water and gas is then admixed, promoting CO₂ uptake into the water in the form of inorganic carbon species, such as carbonate and bicarbonate ions. The resulting carbon-enriched water stream is then moved to a disposal well for injection and carbon storage.

To gain a better understanding of the invention described herein, the following examples are set forth. It should be understood that these examples are for illustrative purposes only. Therefore, they should not limit the scope of this invention in any way.

### EXAMPLES

### Example 1—Calcium Manipulation Electrode System

Feasibility of an electrochemical approach to add or remove calcium ions from seawater was investigated by using a Ca-ion battery electrode consisting of potassium barium iron cyanide [K₂BaFe(CN)₆], a Prussian blue analogue. It was demonstrated that this was an effective means to move calcium ions within the ocean as an effective direct CO₂ capture method. The calcium insertion and de-insertion properties of K₂BaFe(CN)₆ were studied using cyclic voltammetry and galvanostatic charge/discharge methods. Scanning Electron Microscopy (SEM)—Energy Dispersive Spectroscopy (EDS) analysis of the material revealed the cyclic nature of Ca-ion insertion and de-insertion in K₂BaFe(CN)₆. Multiple cycles of the electrode were demonstrated to be possible.

An increase in near surface ocean alkalinity was performed by moving calcium ions between deep ocean and surface ocean water masses by using calcium ion battery electrochemistry. Calcium ion battery electrodes such as V₂O₅(Amatucci et al., 2001), Ca_{0.28}V₂O₅·H₂O (Jeon et al., 2022), MoO₃ (Tojo et al., 2018), CaCO₂O₄(Cabello et al., 2016) and K₂BaFe(CN)₆ (Adil et al., 2018) and (Padigi et al., 2015) may be utilized to intercalate calcium ions from deep ocean water for subsequent release to the surface ocean, thereby promoting the formation of calcium (bi)carbonate. K₂BaFe(CN)₆— a Prussian blue analogue has been reported as a cathode material for an aqueous calcium ion battery (Adil et al., 2018). The schematic of the proposed electrochemical setup is shown in FIG. 5.

In the first step, the Prussian blue analogue electrode—as an example of an effective electrode material—took up the calcium ion into its lattice from an artificially manufactured “deep ocean water” made by adding appropriate salts to water (3.5% sea salt solution); and in the second step, the calcium ions were electrochemically transferred to a “surface ocean water” sample. The released calcium ions combined with hydroxide ions or bicarbonate/carbonate ions to form calcium hydroxide or calcium (bi)carbonate. By this process, the alkalinization of the surface ocean was performed by the electrochemical insertion/decalation of calcium ions into the Prussian blue analogue electrode. The counter electrode for the cell was either a platinum or graphite electrode, in which a gas evolution reaction took place. Dual electrode systems linked through conductive bridges, such as described above for sodium ion mobilization, were also feasible.

The electrochemical characterization of the K₂BaFe(CN)₆ was performed by using cyclic voltammetry and galvanostatic experiments using a three-electrode setup. The electrochemical setup involved the active material K₂BaFe(CN)₆ coated on carbon as a working electrode, a Ag/AgCl (sat. KCl) electrode as a reference electrode, and a graphite rod as a counter electrode. Typical active material slurries were prepared by mixing synthesized K₂BaFe(CN)₆ with 10% of conducting carbon and 10% PVDF (polyvinylidene difluoride) binder on a weight percentage basis. A homogeneous mixture was obtained by mixing the above composition using mortar and pestle with 1-methyl-2-pyrrolidone (NMP) as solvent. The obtained slurry was spread as a coating on carbon cloth over an area of 6 cm². The electrolyte used in the experiment was a model seawater constructed from sea salt (Sigma Aldrich) dissolved at appropriate concentrations in deionized water.

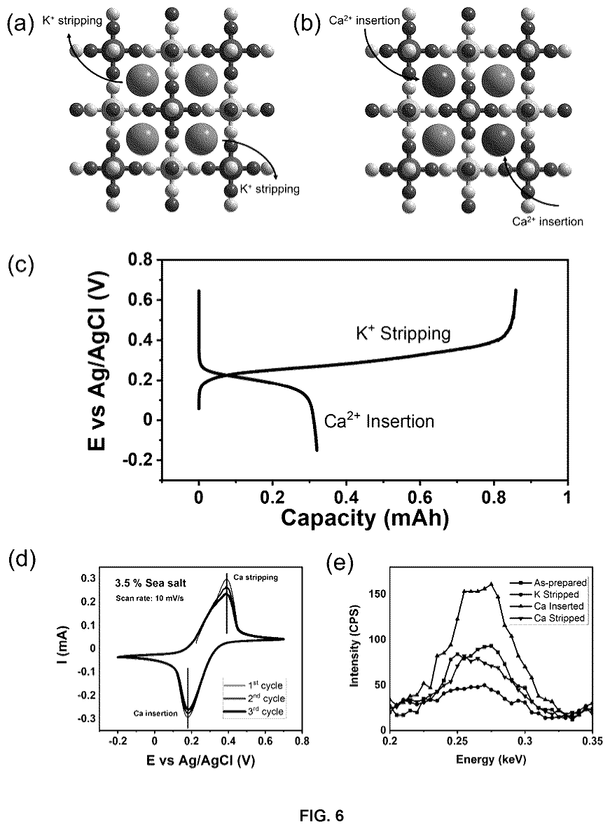

The open structure of the Prussian blue analogue is depicted in FIG. 6(a), and the way in which removal of potassium ions is followed by the insertion of calcium ions is depicted in FIG. 6(b). The cyclic voltammetry response of the as prepared K₂BaFe(CN)₆ electrode is shown in FIG. 6(d). A typical scan rate of 10 mV/s was used with 15 ml of 3.5% sea salt dissolved in deionized water. The potential was scanned between −0.2 V to 0.7 V vs the Ag/AgCl (sat. KCl) reference electrode. Sharp oxidation and reduction peaks were obtained at 0.31 V and 0.15 V vs the Ag/AgCl (sat. KCl) reference electrode. The obtained oxidation and reduction potentials corresponds to the Ca insertion and de-insertion(decalation) potentials as reported in Padigi et al., 2015. In the first step to activate the electrode, K⁺ ions from K₂BaFe(CN)₆ were stripped from the electrolyte, and in the reverse scan Ca²⁺ ions were inserted into the K₂BaFe(CN)₆ lattice according to equations 5 and 6, below. In subsequent cycles, the Ca insertion/de-insertion takes place as shown in equation 6.

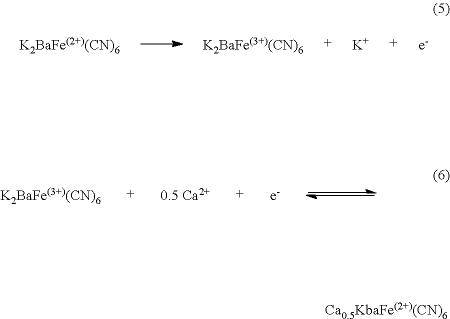

In a similar three-electrode setup, the calcium mobilization electrode was subjected to galvanostatic charge/discharge cycles to initially strip K⁺ electrochemically from the lattice and promote the subsequent calcium ion insertion into the electrode lattice as shown in FIG. 6 €. The loading of the Prussian blue analogue electrode was 5 mg/cm². The plateau obtained between 0.3 to 0.45 V vs Ag/AgCl showed the stripping of potassium ions in the first step. The subsequent insertion of calcium ions was depicted by the plateau at 0.2 V vs the Ag/AgCl reference electrode. Similar electrodes were prepared with the same loading of 5 mg/cm² of active component and the electrode at each step—as prepared (dipped in 3.5% sea salt for 10 mins), K⁺ stripped, Ca²⁺ inserted, and Ca²⁺ ion stripped—was taken out and washed with DI water for SEM/EDS analysis. The electrode from each step was used for EDS analysis to confirm the process of calcium insertion/decalation in the electrode, as shown in FIG. 6(e).

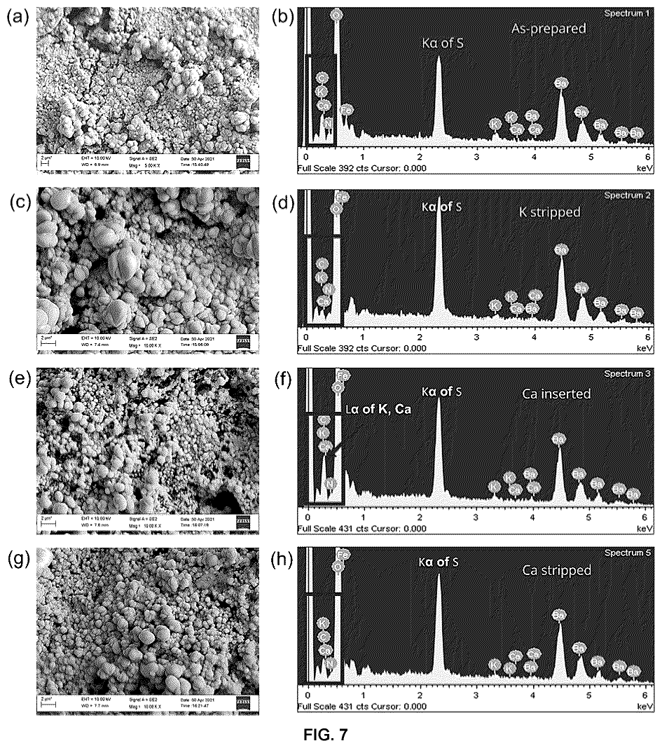

The SEM images of the electrode (see FIG. 7. a, c, e, g), along with the EDS spectra of the respective electrodes in each step (see FIG. 7. b, d, f, h), are shown in FIG. 7. In the potassium-stripped electrode, the SEM-EDS peak corresponding to K was reduced, indicating the removal of K⁺ ions from the lattice and, in the Ca-inserted and Ca-stripped electrodes, the Ca peak was observed to be increasing and decreasing showing the insertion and decalation of calcium ions in the lattice.

The theoretical specific capacity of K₂BaFe(CN)₆ is 69 mAh/g. As a proof- of-concept, the moles of K⁺ ions stripped and Ca²⁺ ions inserted were calculated for different mass loading of electrode material of 5, 10 and 15 mg/cm². The K⁺ stripping step was carried out with a C-rate of C/20 and the calcium insertion step was carried out with a C-rate of C/15 in all conditions. (Note: C-rate is a measure of the rate at which an electrode is charged/discharged relative to its maximum capacity. For example, if there is an electrode with a capacity of 4 mAh, 1 C means utilizing all capacity in 1 hour; by carrying out an experiment with a current of 4 mA, 2 C means utilizing all capacity in half an hour; by carrying out the experiment with a current of 8 mA, C/20 means utilizing all capacity in 20 hour; by carrying out the experiment with a current of 0.2 mA: C/15 means utilizing all capacity in 15 hour; by carrying out the experiment with a current of 0.26 mA).

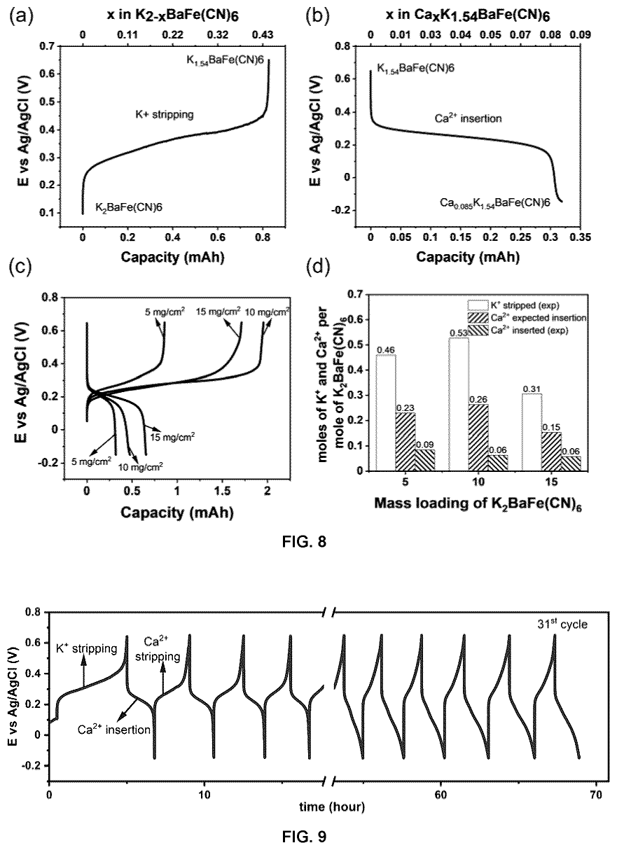

FIGS. 8 (a) and (b) shows the K⁺ stripping and Ca²⁺ insertion step with the corresponding moles of ions plotted on the upper x-axis. It was observed that, for 5 mg/cm² loading, 0.46 moles of K⁺ ions were stripped vs the expected 1 mole of K⁺ ions from the structure. The expected Ca²⁺ ions insertion capacity was half of the K⁺ stripped value (Equation 6). The calcium ion insertion was 0.09 moles vs the expected 0.23 moles for 5 mg/cm² loading. With increase in mass loading, no significant improvement in K⁺ stripping and Ca²⁺ insertion capacities were obtained. Allowing for these stoichiometric inefficiencies would be part of the design plan in constructing practical, efficient actual electrodes. The plot of capacity (mAh) vs potential and the moles of K⁺ stripped and Ca²⁺ inserted are shown in FIGS. 8 (c) and (d) respectively. While the process was not 100% efficient, the system does provide a repeatable means of mobilizing calcium ions from one water mass to another and thus provided a practical component of the system able to modify surface water chemistry and promote CO₂ uptake from the atmosphere.

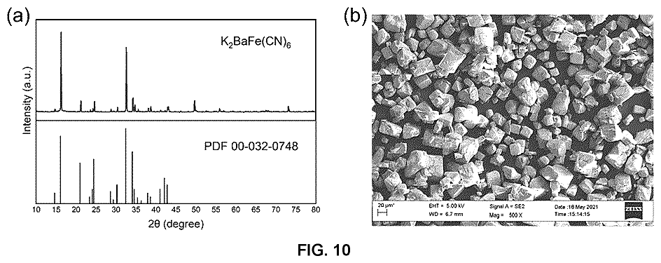

Galvanostatic cycling was repeated over multiple cycles to determine the reversible insertion/de-insertion of Ca with K₂BaFe(CN)₆. The results obtained are tabulated in Table 1 below. With 10 mM concentration of Ca (3.5% sea salt in DI water), the electrode was able to reversibly insert/de-insert calcium up to the 31 cycles tested. It was observed from the results that the calcium insertion capacity of ˜0.2 mAh was retained up to 31 cycles with 5 mg/cm² K₂BaFe(CN)₆ loading and 10 mM Ca concentration (3.5% sea salt solution). As shown in FIG. 9, symmetric charge/discharge curves were obtained with reversible cycles. The summary of the charge and corresponding calcium ion mobilization changes are listed in Table 1.

TABLE 1
Calcium insertion capacity obtained with
galvanostatic charge/discharge cycling.

| | | | Final insertion | Mass of |
|---|---|---|---|---|
| Concentration | Ca insertion | | capacity at the | calcium |
| of Ca in | capacity in | | end of stable | inserted |
| 3.5% sea salt | first cycle | Stable | cycles | in final |
| solution | (mAh) | cycles | (mAh) | cycle (mg) |
| 10 mM | 0.22 | 31 | 0.2 | 0.15 |

To summarize, an aqueous calcium ion battery electrode K₂BaFe(CN)₆ was utilized to demonstrate a means to extract and then deliver calcium ions from and to seawater solutions. The stability of the material over repeated cycling showed excellent stability with a test run of up to 31 cycles with a mass loading of 5 mg/cm². This reversible insertion and de-insertion of calcium ions in the Prussian blue analogue lattice, together with the seawater mobilization system described herein, provides an approach to modifying surface seawater composition by increasing the alkalinity of near surface seawater and thus promoting CO₂ uptake by the near surface ocean, with atmospheric CO₂ being stored securely as bicarbonate ion.

Synthesis of K₂BaFe(CN)₆. Potassium barium hexacyanoferrate (K₂BaFe(CN)₆) was synthesized by using a wet chemical precipitation method (Padigi et., 2015). 0.1M solution of barium nitrate in deionized water was added drop by drop into 0.5 M solution of potassium ferrocyanide in deionized water with stirring at room temperature. The resulting K₂BaFe(CN)₆ precipitate was washed with deionized water for 3 times by using centrifugation at 2000 rpm for 10 minutes. The separated K₂BaFe(CN)₆ powder was dried in a vacuum oven at 40° C. overnight.

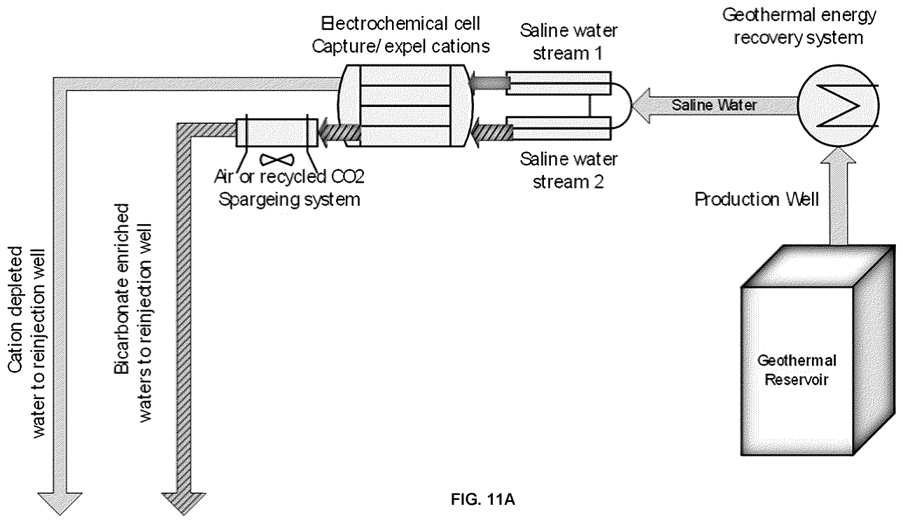

Characterization. The characterization of the synthesized K₂BaFe(CN)₆ powders was performed using powder X-ray diffraction (PXRD) on a D8 Advance (Bruker, Cu Kα, 40 kV, 40 mA, U of Calgary). The cyclic voltammetry and galvanostatic experiments were carried out using VSP-300 Biologic potentiostat. The PXRD patterns of the synthesized K₂BaFe(CN)₆ is shown in FIG. 10(a). The XRD peaks showed the crystalline form of K₂BaFe(CN)₆ with peaks matching with PDF 00-032-0748. The SEM image of the as prepared K₂BaFe(CN)₆ is shown in FIG. 10(b).

### Calcium Ion Electrode Titration Results

Electrode preparation by electrochemical expulsion of K⁺ ions in one batch of synthetic seawater solution (3.5% sea salt solution, sea salt purchased from Sigma Aldrich), and subsequent insertion of Ca²⁺ ions, was performed in another batch of synthetic seawater solution. The sea salt purchased from Sigma Aldrich had the following composition (mg/L): Chloride 19000-20000; Sodium 10700-11000; Sulfate 2660; Potassium 300-400; Calcium 400; Carbonate 140-200; Boron 5.6; Magnesium 1320; Strontium 8.8. The Ca²⁺ inserted-potassium barium iron cyanide (PBFC) electrode was washed, and moved to a fresh batch of synthetic seawater in which Ca²⁺ ions were electrochemically expelled. The alkalinity of the synthetic seawater was 2.18±0.01 mEq/kg and the alkalinity of the Ca²⁺ ion-expelled solution was 2.24±0.01 mEq/kg. Hence, there was observed a 2.75% increase in alkalinity of the solution in one cycle of the experiment. The titration results are summarized in Table 2.

TABLE 2
Summary of alkalinity results using
a Prussian blue analogue electrode.

| | | Alkalinity |
|---|---|---|
| | Electrochemical step | (mEq/kg) |
| 1 | As-prepared synthetic seawater | 2.18 ± 0.01 |
| 2 | Ca²⁺ insertion into electrode | 2.11 ± 0.01 |
| | (e.g., in Deep Ocean water) | |
| 3 | Ca²⁺ expulsion from electrode to | 2.24 ± 0.02 |
| | solution (e.g., in Surface Ocean water) | |

### Example 2—Sodium Studies

### Materials

LiFePO₄ (LFP) purchased from MTI corporation. Super P conductive carbon, 15% NAFION dispersion, and graphite felt purchased from Fuel Cell store.

### Electrode Preparation

LFP powder and conductive carbon were mixed in a ratio of 8:1 in a mortar and pestle. A measured volume of NAFION dispersion was added so that the final mass of the mixture was in a at 8:1:1 ratio of LFP, Conductive carbon, and NAFION. Isopropanol was added to the mixture to make the mixture into a slurry. The graphite felt used in the experiment was treated with 3:1 mixture of 1 M HNO₃ and 1 M H₂SO₄ for 24 hours, and dried at 100° C. for 12 hours before use. The graphite felt was cut into 2 cm×1 cm pieces and the prepared slurry was coated to an area of 1 cm×1 cm by masking the remaining area. The initial and coated mass of the graphite felt was measured to obtain the mass loading of the active material LFP.

Electrochemical Conversion of LiFePO₄ (LFP) to FePO₄ (FP)

The LFP-coated graphite felt electrode was assembled in a three-electrode electrochemical setup with LFP-coated graphite felt as the working electrode, Ag/AgCl (sat. KCl) as the reference electrode, and platinum as the counter electrode. The LFP was oxidized by applying a constant current (current normalized to the mass of active material to consume full capacity in 10 hours) with a potential limitation of 0.6 V vs Ag/AgCl. The electrolyte used was 15 ml solution of synthetic seawater.

### Electrochemical Na⁺ Ions Insertion and Expulsion

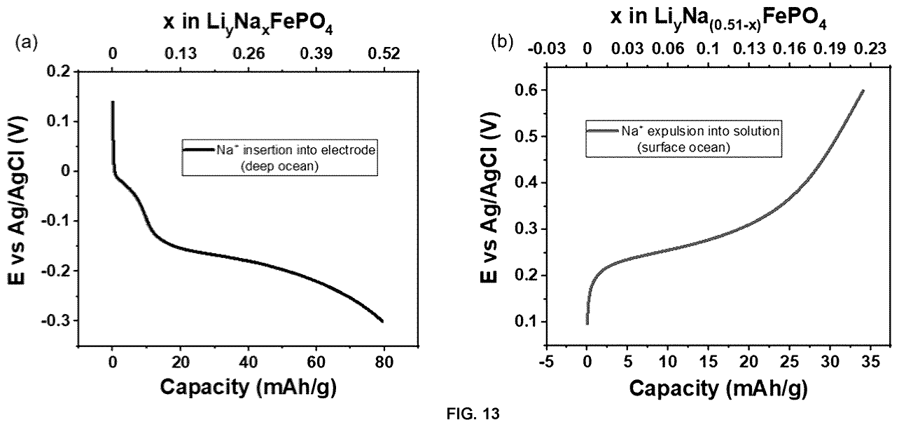

The electrochemically prepared FP electrode was used for insertion and expulsion of Na⁺ ions using a similar three electrode setup with fresh synthetic seawater at each stage. The electrolyte used for the Na⁺ ions insertion into FP electrode and the expulsion of Na⁺ ions from NaFePO₄ (NFP) electrodes were used for alkalinity analysis. The obtained potential plateau is shown in FIGS. 13 (a) and (b) and is consistent with the observation by (Fang et al. 2015).

The reactions happening at both cells during sodium ion insertion and expulsion are as follows:

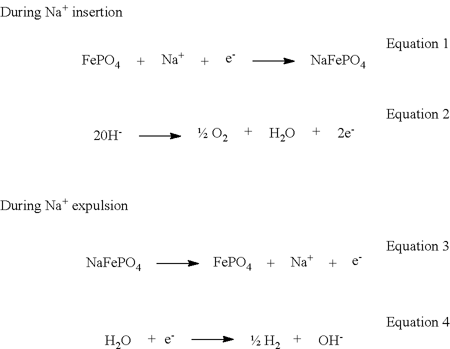

The expulsion of Na⁺ ions into seawater and the simultaneous evolution of H₂ gas at the counter electrode leaves behind OH⁻ ions in the surface water. The net reaction governing the uptake of CO₂ into ocean can be given as

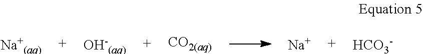

where the CO_{2 (aq)} is obtained from the dissolution of atmospheric CO₂ into seawater as dissolved CO₂. Thus, the net process is transferring alkalinity from one portion of the ocean (deep ocean) to another portion of the ocean (surface ocean). The deep ocean, which is not in equilibrium with the atmosphere, does not release CO₂ into the atmosphere by losing alkalinity. However, for the surface ocean, which is in equilibrium with the atmosphere, increased alkalinity can dissolve more CO₂ as per the Equation 5.

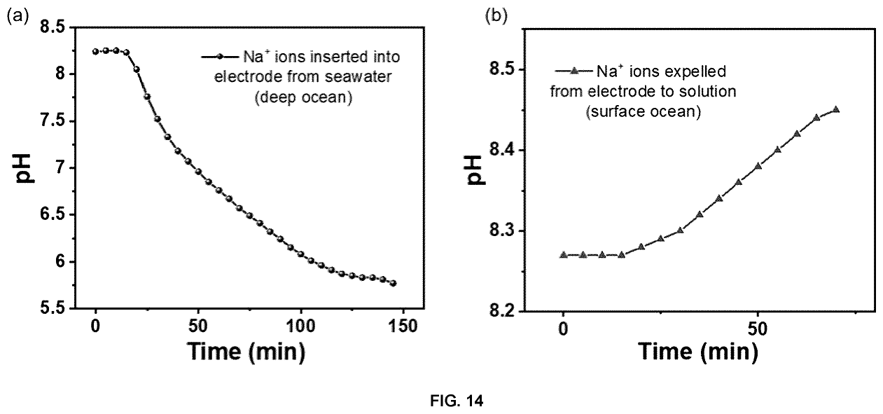

The electrochemical reactions in Equations 1 to 2 (which, for example, may occur in deep ocean water) consumes Na⁺ ions and OH⁻ ions, which can be confirmed by the decrease in pH of the solution as shown in FIG. 14 (a). Similarly, for the reactions in Equations 3 and 4 (which, for example, may occur in surface water of the ocean), the expelled Na⁺ ions and OH⁻ ions generated at the counter electrode by consumption of water molecules results in the increase in pH as shown in FIG. 14 (b).

The overall process of alkalinity change with the process can be studied experimentally by titration of resulting solutions from the Na⁺ ions insertion and Na⁺ ions expulsion steps, as follows:

| | | Alkalinity |
|---|---|---|
| | Electrochemical step | (mEq/kg) |
| 1 | As-prepared synthetic seawater | 2.10 ± 0.01 |
| 2 | Na⁺ insertion into electrode | 1.89 ± 0.05 |
| | (e.g., in Deep Ocean water) | |
| 3 | Na⁺ expulsion from electrode to | 2.45 ± 0.01 |
| | solution (e.g., in Surface Ocean water) | |

### Example 3—Chloride Studies

### Materials

Pyrrole (Sigma Aldrich) and graphite felt were purchased from Fuel Cell store.

### Electrode Preparation

The graphite felt used in the experiment was treated with a 3:1 mixture of 1 M HNO₃ and 1 M H₂SO₄ for 24 hours and dried at 100° C. for 12 hours before use. The graphite felt was cut into 2 cm×1 cm pieces and the initial weight of the graphite felt was measured. The polypyrrole electrodes were prepared by electrochemical polymerization of pyrrole in a three-electrode setup with the treated graphite felt as working electrode, Ag/AgCl as reference electrode, and titanium mesh as counter electrode. The method used (Pu et al.) was followed to prepare the polypyrrole electrodes.

### Electrochemical Cl⁻ Ion Insertion and Expulsion

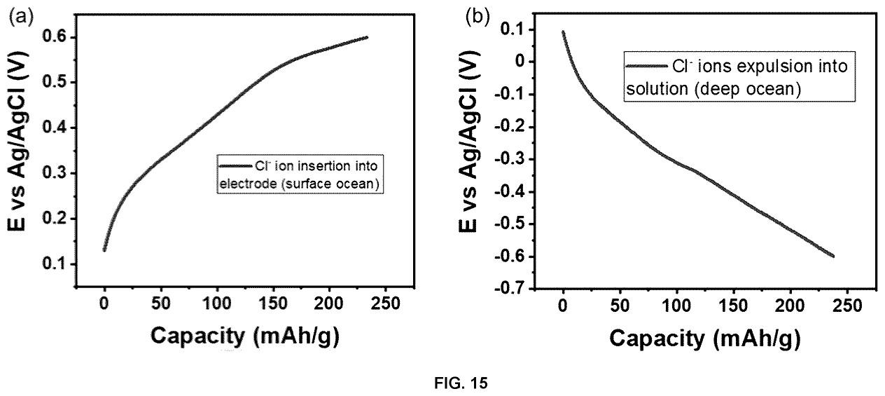

The electrochemically prepared polypyrrole electrode was used for insertion and expulsion of Cl⁻ ions using a similar three electrode setup with fresh synthetic seawater at each stage. FIG. 15 shows the electrochemical insertion and expulsion of Cl— ions in the polypyrrole electrode.

The reactions happening during chloride ion insertion and expulsion are as follows.

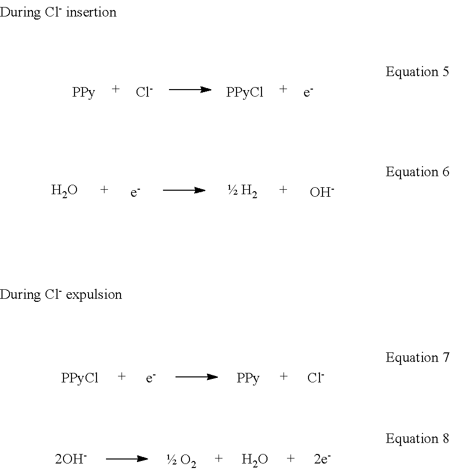

The alkalinity analysis of the resulting Cl⁻ depleted (e.g., in surface ocean water) and Cl⁻ enriched (e.g., in deep ocean water) are as follows.

| | | Alkalinity |
|---|---|---|
| | Electrochemical step | (mEq/kg) |
| 1 | As-prepared synthetic seawater | 2.28 ± 0.01 |
| 2 | Cl⁻ insertion into electrode | 2.47 ± 0.00 |
| | (e.g., in Surface Ocean water) | |
| 3 | Cl⁻ expulsion from electrode to | 1.23 ± 0.02 |
| | solution (e.g., in Deep Ocean water) | |

### Examples 1-3: Supporting Information

### Alkalinity Titration Details

Titration reactions and results described in Examples 1-3 are general reactions in terms of alkalinity titration. The as-written reactions below reference the Na⁺ and Cl⁻ examples, but apply to the Ca⁺ examples where Na⁺ salts in the reactions re replaced with Ca⁺ salts. The alkalinity measurements were done using an Orion Star T910 auto titrator by titrating against 0.02 N Sulfuric Acid.

The alkalinity measurements were first done with known concentration of bicarbonate ions—2.11 mM Sodium bicarbonate solution (Measured alkalinity value 2.1 mEq/kg). In this titration method, to measure alkalinity 0.02 N H₂SO₄ was added to the experimental solution and the pH of the solution was measured. The volume of acid required to bring the pH to 4.2 was taken and used to calculate the concentration of acid required to measure the buffering capacity of seawater.

The following are the sequence of reactions that take place during the titration experiment:

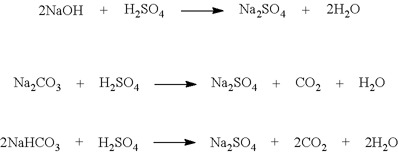

At first, all the NaOH in the solution is consumed and then carbonates and bicarbonates are consumed. The end point is 4.2 pH, at which all bicarbonates are consumed by sulfuric acid.

### Example 1-3: References

Fang, Yongjin, et al. “High-Performance Olivine NaFePO4 Microsphere Cathode Synthesized by Aqueous Electrochemical Displacement Method for Sodium Ion Batteries.” ACS Applied Materials and Interfaces, vol. 7, no. 32, 2015, pp. 17977-84, doi:10.1021/acsami.5b04691.

Pu, Kai Bo, et al. “In Situ Synthesis of Polypyrrole on Graphite Felt as Bio-Anode to Enhance the Start-up Performance of Microbial Fuel Cells.” Bioprocess and Biosystems Engineering, vol. 43, no. 3, Springer Berlin Heidelberg, 2020, pp. 429-37, doi:10.1007/s00449-019-02238-y.

### Example 4—Hydrogen-Ion Storage Electrodes for Use in PEACH Methods and Systems

As described herein, a transfer of ion-concentration and/or alkalinity may be done by using electrochemical cells that can selectively insert/strip ions, such as Na⁺, Ca²⁺, Cl⁻ ions. It is recognized that electrochemical cells have two electrochemical reactions for charge balance, and in the electrochemical setup described in Examples 1-3, the counter-reaction to the ion insertion/expulsion into electrode materials are gas evolution reactions.

For example, an overall Na⁺ insertion/expulsion process can be summarized as follow, in which a working electrode (WE) is taken as FePO₄, and a counter electrode can be any inert electrodes, like Platinum (Pt) or graphite:

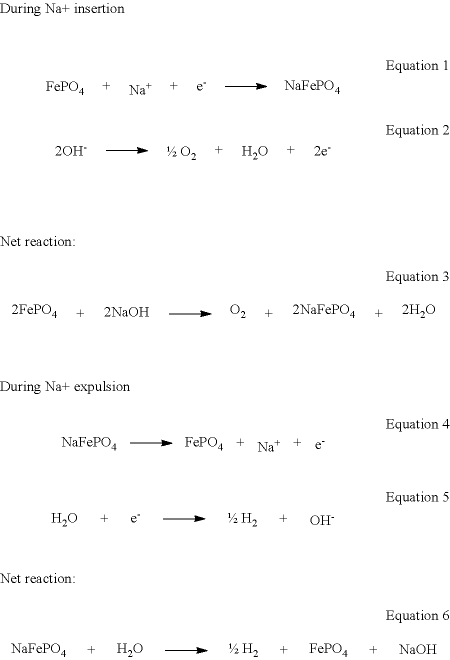

The generation of Na⁺ and OH⁻ ions can promote carbon capture and/or enhanced alkalinity in water masses or aliquots, like a surface water of a lake, sea, or ocean.

The energy requirement for electrochemical processes generally depend on the potential of the electrochemical cells. The potential of the electrochemical cells can be calculated by the difference in potential between the cathode reaction (reduction) to the anode reaction (oxidation). In this way, the net theoretical potential of the Na+ insertion/expulsion electrochemical cells is as below:

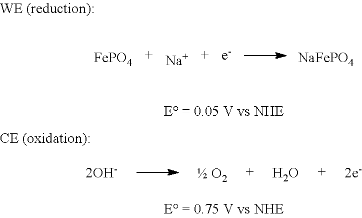 [SMILES: "FePO4" ; [Na+] ; "NaFePO4" ; "2OH-" ; O]

Potential of the Na⁺ ions insertion step (E° reduction−E° oxidation)=0.05-0.75=−0.7 V

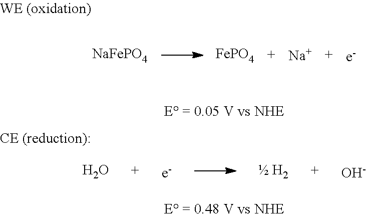

Potential of the Na⁺ ions expulsion step (E° reduction—E° oxidation)=−0.48-0.05=−0.53 V

The electrochemical potential requirement for the total process is calculated to (−)1.23 V. The negative signs in the individual potential steps indicate that the reactions are non-spontaneous and require energy to perform the reaction.

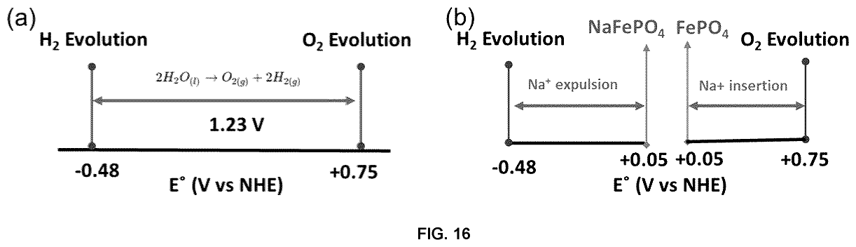

The two-step process of Na⁺ ions insertion and expulsion can be considered akin to separating the electrolysis process of splitting water into H₂ gas and O₂ gas into two smaller processes. FIG. 16 depicts the difference between the water-splitting electrolysis process and the Na⁺ ion insertion/expulsion process.

### Hydrogen Intercalation/Storage Electrodes

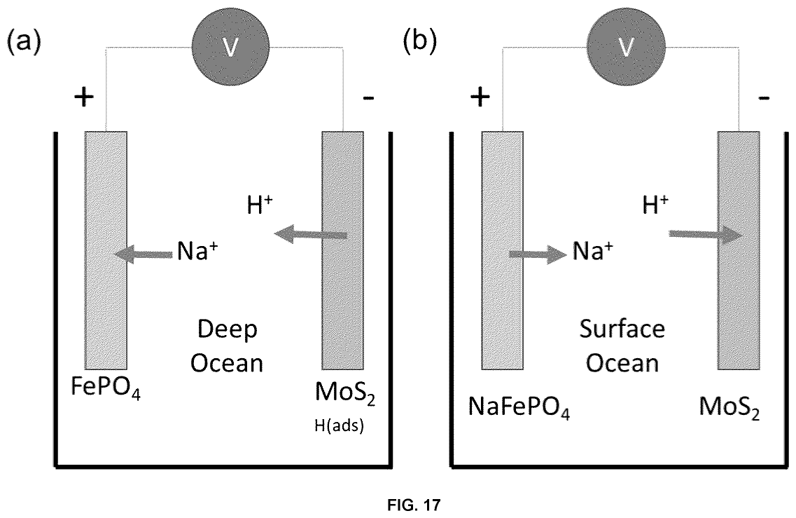

The potential requirement for the overall exemplary Na+ ions insertion/expulsion process may be further reduced by replacing the counter electrode in both insertion and expulsion steps with H+ intercalation/insertion electrodes, or H+ ion storage electrodes—such as MoS₂; Mg, Ni & Co alloys; MoS₂-carbon composites; Mg, Ni & Co alloy-carbon composites; or a combination thereof, where the carbon component comprises condensed carbon phases, such as graphene, fullerene, carbon nanotubes, multi-walled carbon nanotubes, etc. and derivatives thereof (Eftekhari and Fang 2017). The schematic of such a cell with MoS₂ as exemplary electrode is shown FIG. 17.

The overall reactions of a Na⁺ ions insertion/expulsion process using with H+ intercalation/insertion electrodes or hydrogen-storing electrodes can be summarized as follows. In this example, the potential requirement for the steps may be calculated as below. Potential for MoS₂ hydrogen storage is (−0.6 V) (Jun Chen et al. 2001; J. Chen et al. 2003).

### Expected Charge/Discharge Reactions:

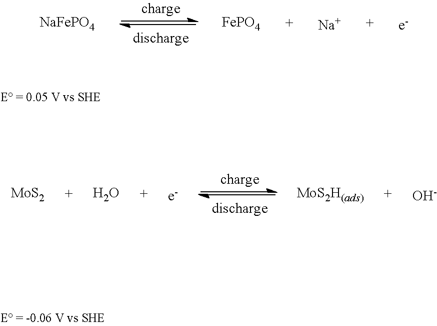

Na⁺ ions insertion step (e.g., in deep water of ocean):

WE (reduction): Na+ ions inserted into FePO₄ electrode.
CE (oxidation): hydrogen ions expelled from MoS₂ electrode.
Potential (E° reduction−E° oxidation)=0.05 −(−0.6)=0.65 V (e.g., like discharging of a battery)

Na⁺ ions expulsion step (e.g., in surface water of ocean): WE (reduction): Na+ ions expelled from NaFePO₄ electrode.

CE (reduction): hydrogen ions inserted/adsorbed into MoS₂ electrode.
Potential (E° reduction−E° oxidation)=−0.6-0.05=−0.65 V (e.g., like charging of a battery)

As can be seen for the Na⁺ ion insertion step, the potential is positive. This suggests that it is a spontaneous reaction—like the discharge reaction of a battery. In contrast, the Na⁺ ion expulsion step has a negative potential, which suggests it is a non-spontaneous reaction, like the charging step of a battery. As such, by replacing gas-evolution electrodes with H⁺ insertion electrodes, the net potential for the overall insertion/expulsion process can be decreased from 1.23 V to 0.65 V. As such, the energy requirement for the process may be reduced, where the energy requirement for an electrochemical process can be calculated by multiplying the potential times the charge [(E=V×I×t) where E is energy required in Wh, V is potential in volts, I is current in A, and t is time in hour]. Further, engineering the electrochemical cell of the herein described methods and systems may be simplified, as there is a reduced need or no need for gas storage/handling.

The overall exemplary reaction can be express as follows, where the final product includes Na⁺ and OH⁻ ions—which can promote uptake of CO₂ as forms of carbonates and bicarbonates in solution.

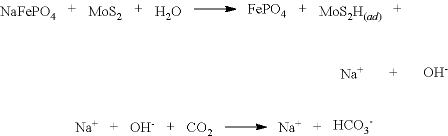

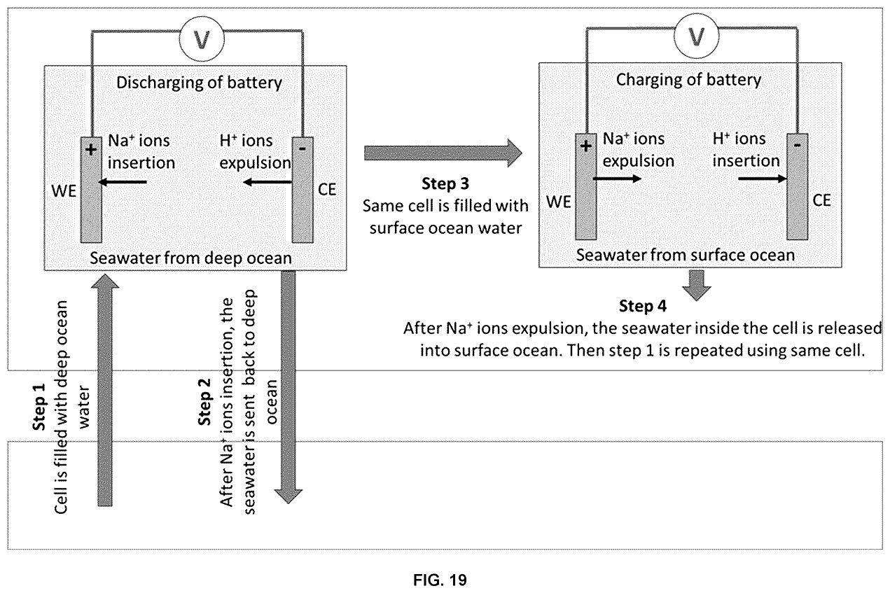

FIG. 19 depicts an exemplary electrochemical setup to move a sodium ion-water stream from deep water, such as the deep ocean, to surface water, such as surface ocean water. With reference to FIG. 19, the depicted ion-selective electrode functions to change water chemistry in the following manner. An electrochemical cell is provided, the cell comprising ion insertion/expulsion electrodes, such as Na⁺ or Ca²⁺ selective electrodes (WE: working electrodes) and a H⁺ ion storage/expulsion electrode (CE: hydrogen-storing counter electrode). In step 1 of FIG. 19, the electrochemical cell is filled with deep ocean water and Na⁺ ions are inserted into the WE while H⁺ ions are expelled from the CE in a spontaneous reaction that is akin to discharging a battery. In step 2, the cell is emptied and the deep ocean water inside the cell is sent back to the deep ocean. In step 3, the same cell is filled with surface ocean water, and the Na⁺ ions are expelled into that water from the WE while H⁺ ions are inserted into the CE in a non-spontaneous reaction that is akin to charging a battery. In step 4, the increased-Na⁺ water in the cell is released into surface ocean, which can facilitate capture of atmospheric CO₂ into the surface water as inorganic carbon species, such as carbonate or bicarbonate ions. Additionally, by using the H⁺ ion storage/expulsion electrode in the electrochemical cell, that cell can act as a battery and thus may act a source of energy for use where needed, for reducing operating costs, etc.

### Example 4 References

Chen, J., et al. “Novel Hydrogen Storage Properties of MoS2 Nanotubes.” Journal of Alloys and Compounds, vol. 356-357, 2003, pp. 413-17, doi:10.1016/S0925-8388(03)00114-2.

Chen, Jun, et al. “Electrochemical Hydrogen Storage in MoS 2 Nanotubes.” Journal of the American Chemical Society, vol. 123, no. 47, November 2001, pp. 11813-14, doi:10.1021/ja017121z.

Eftekhari, Ali, and Baizeng Fang. “Electrochemical Hydrogen Storage: Opportunities for Fuel Storage, Batteries, Fuel Cells, and Supercapacitors.” International Journal of Hydrogen Energy, vol. 42, no. 40, Elsevier Ltd, 2017, pp. 25143-65, doi:10.1016/j.ijhydene.2017.08.103.

### Background, Introduction, Detailed Description, Additional Example 1 References

Adil, M., Dutta, P. K. & Mitra, S. An Aqueous Ca-ion Full Cell Comprising BaHCF Cathode and MCMB Anode. ChemistrySelect 3, 3687-3690 (2018) DOI: 10.1002/slct.201800419. Alonso, A. et al. Critical review of existing nanomaterial adsorbents to capture carbon dioxide and methane. Sci. Total Environ. 595, 51-62 (2017) DOI: 10.1016/J.SCITOTENV.2017.03.229.
Amatucci, G. G. et al. Investigation of Yttrium and Polyvalent Ion Intercalation into Nanocrystalline Vanadium Oxide Investigation of Yttrium and Polyvalent Ion Intercalation into Nanocrystalline Vanadium Oxide. J. Electrochem. Soc. 148 (8), A940-A950 (2001).
Bach, L. T., Gill, S. J., Rickaby, R. E. M., Gore, S. & Renforth, P. CO₂ Removal With Enhanced Weathering and Ocean Alkalinity Enhancement: Potential Risks and Co-benefits for Marine Pelagic Ecosystems. Front. Clim. 1, (2019) DOI: 10.3389/FCLIM.2019.00007/FULL.
Bajaj, P. & Thakur, S. Carbon Dioxide Capture and Sequestration to Achieve Paris Climate Targets. in Climate Change 215-233 (Springer International Publishing, 2022). DOI: https://doi.org/10.1007/978-3-030-86290-9_13.
Cabello, M. et al. Advancing towards a veritable calcium-ion battery: CaCo2O4 positive electrode material. Electrochem. commun. 67, 59-64 (2016) DOI: https://doi.org/10.1016/j.elecom.2016.03.016.
Chang, J., Duan, F., Su, C., Li, Y. & Cao, H. Environmental Science Water Research & Technology electrode in capacitive deionization (CDI). 373-382 (2020). doi:10.1039/c9ew00985j
Chen, F., Huang, Y., Guo, L., Sun, L., Wang, Y. and Yang, H. Y., 2017. Dual-ions electrochemical deionization: a desalination generator. Energy & Environmental Science, 10(10), pp. 2081-2089.
Deng, C., Zhang, S., Dong, Z. & Shang, Y. 1D nanostructured sodium vanadium oxide as a novel anode material for aqueous sodium ion batteries. Nano Energy 4, 49-55 (2014).
Digdaya, I. A. et al. A direct coupled electrochemical system for capture and conversion of CO₂ from oceanwater. Nat. Commun. 11, 1-10 (2020) DOI: 10.1038/s41467-020-18232-y.
Doney, S. C., Fabry, V. J., Feely, R. A. & Kleypas, J. A. Ocean acidification: The other CO₂ problem. Ann. Rev. Mar. Sci. 1, 169-192 (2009) DOI: 10.1146/annurev.marine.010908.163834.
Falkowski, P. et al. The global carbon cycle: A test of our knowledge of earth as a system. Science (80—). 290, 291-296 (2000) DOI: 10.1126/SCIENCE.290.5490.291/ASSET/17F45F53-E3CB-4FB4-B3F7-4AEB7B5A3C55/ASSETS/GRAPHIC/SE3908898002.JPEG.
Halevy 1, and Bachan A. (2017) The geologic history of seawater pH. Science 355, 1069-1071.
Jeon, B., Kwak, H. H. & Hong, S.-T. Bilayered Ca 0.28 V 2 O 5 ·H 2 O: High-Capacity Cathode Material for Rechargeable Ca-lon Batteries and Its Charge Storage Mechanism. Chem. Mater. 34, 1491-1498 (2022) DOI: 10.1021/ACS.CHEMMATER.1CO₂₇₇₄/SUPPL_FILE/CM1CO₂₇₇₄_SI_001.PDF.
Jiao, N., Herndl, G. J., Hansell, D. A., Benner, R., Kattner, G., Wilhelm, S. W., Kirchman, D. L., Weinbauer, M. G., Luo, T., Chen, F., Azam, F., 2010. Microbial production of recalcitrant dissolved organic matter: long-term carbon storage in the global ocean. Nature Reviews Microbiology 8, 593. IPCC, 2013. Fifth Assessment Report of the Intergovernmental Panel on Climate Change.
Khan, M. A., AI-Attas, T., Roy, S., Rahman, M. M., Ghaffour, N., Thangadurai, V., Larter, S., Hu, J., Ajayan, P. M. and Kibria, M. G., 2021. Seawater electrolysis for hydrogen production: a solution looking for a problem?. Energy & Environmental Science. https://doi.org/10.1039/D1EE00870F
Kheshgi, H. S., 1995. Sequestering atmospheric carbon dioxide by increasing ocean alkalinity. Energy, 20(9), pp.915-922)
Kong, H., Yang, M., Miao, Y. and Zhao, X., 2019. Polypyrrole as a Novel Chloride-Storage Electrode for Seawater Desalination. Energy Technology, 7(11), p.1900835.
Lauer, R. M., Fisher, A. T. and Winslow, D. M., 2018. Three-dimensional models of hydrothermal circulation through a seamount network on fast-spreading crust. Earth and Planetary Science Letters, 501, pp. 138-151.
Lee C.-T. A., Jiang H., Dasgupta R. and Torres M., 2019. A Framework for Understanding Whole-Earth Carbon Cycling. In Deep Carbon: Past to Present Cambridge University Press. pp. 313-357.Marchetti, C. On geoengineering and the CO₂ problem. Clim. Change 1, 59-68 (1977) DOI: 10.1007/BF00162777.
Ozkan, M., Nayak, S. P., Ruiz, A. D. & Jiang, W. Current Status and Pillars of Direct Air Capture Technologies. iScience 103990 (2022) DOI: https://doi.org/10.1016/j.isci.2022.103990.
Padigi, P., Goncher, G., Evans, D. & Solanki, R. Potassium barium hexacyanoferrate—A potential cathode material for rechargeable calcium ion batteries. J. Power Sources 273, 460-464 (2015) DOI: 10.1016/j.jpowsour.2014.09.101.
Pasta, M., Wessells, C. D., Cui, Y. & Mantia, F. La. A Desalination Battery. Nano Lett. 23-27 (2012).
Pilson, M. An Introduction to the Chemistry of the Sea. (Cambridge University Press, 2012). Rau, G. H.,
Rau 2014 U.S. Pat. No. 8,764,964 B2(Rau, Gregory Hudson. “Electrochemical formation of hydroxide for enhancing carbon dioxide and acid gas uptake by a solution.” U.S. Pat. No. 8,177,946, issued May 15, 2012)
Rau, G. H. Enhancing the Ocean's Role in CO₂ Mitigation. Glob. Environ. Chang. 817-824 (2014) DOI: 10.1007/978-94-007-5784-4_54.
Renforth, P. & Henderson, G. Assessing ocean alkalinity for carbon sequestration. Rev. Geophys. 55, 636-674 (2017) DOI: 10.1002/2016RG000533.
Saurel, D., Acebedo, B., Rojo, T., Casas-cabanas, M. & Fern, A. J. Electrochemical characterization of NaFePO 4 as positive electrode in aqueous sodium-ion batteries. J. Power Sources 291, 40-45 (2015).
Sharifian, R., Wagterveld, R., Digdaya, I., Xiang, C. & Vermaas, D. Electrochemical carbon dioxide capture to close the carbon cycle. Energy Environ. Sci. 14, 781-814 (2021) DOI: 10.1039/DOEE03382K.
Song, W. et al. Aqueous Sodium-Ion Battery using a Na 3 V 2 (PO 4) 3 Electrode. ChemElectroChem 2, 871-876 (2014).
Stumm W. and Morgan J. J. (1996) Aquatic chemistry: chemical equilibria and rates in natural waters., John Wiley & Sons, New York, NY.
Tae, I. Surfactant-assisted ammonium vanadium oxide as a superior cathode for calcium-ion batteries. J. Mater. Chem. A Mater. energy Sustain. 6, 22645-22654 (2018).
Tojo, T., Tawa, H., Oshida, N., Inada, R. & Sakurai, Y. Electrochemical characterization of a layered α-MoO 3 as a new cathode material for calcium ion batteries. J. Electroanal. Chem. 825, 51-56 (2018).
Turley, C. et al. The societal challenge of ocean acidification. Mar. Pollut. Bull. 60, 787-792 (2010) DOI: 10.1016/j.marpolbul.2010.05.006.
Tyka, M. D., Van Arsdale, C. & Platt, J. C. CO 2 capture by pumping surface acidity to the deep ocean. Energy Environ. Sci. 15, 786 (2022) DOI: 10.1039/d1ee01532j.
Venkatesan, S. V., K Karan, S Larter, V Thangadurai, JR Radovic U.S. patent application Ser. No. 16/992,083
Wang, Y. et al. Ultra-low cost and highly stable hydrated FePO 4 anodes for aqueous sodium-ion battery. J. Power Sources 374, 211-216 (2018).
Willauer, H. D. and Ren, Z. J., 2018. The global potential for converting renewable electricity to negative-CO 2-emissions hydrogen. Nature Climate Change, 8(7), pp. 621-625.
Winslow, D. M., Fisher, A. T., Stauffer, P. H., Gable, C. W. and Zyvoloski, G. A., 2016. Three-dimensional modeling of outcrop-to-outcrop hydrothermal circulation on the eastern flank of the Juan de Fuca Ridge. Journal of Geophysical Research: Solid Earth, 121(3), pp. 1365-1382.
Zeebe, R. E. History of seawater carbonate chemistry, atmospheric CO 2, and ocean acidification. Annu. Rev. Earth Planet. Sci. 40, 141-165 (2012) DOI: 10.1146/annurev-earth-042711-105521.
Zhang, F., Li, W., Xiang, X. & Sun, M. Highly stable Na-storage performance of Na0.5Mn0.5Ti0.5O2 microrods as cathode for aqueous sodium-ion batteries. J. Electroanal. Chem. 802, 22-26 (2017).

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A method of changing ion concentrations for forming inorganic carbon species, the method comprising
providing a first aqueous solution comprising a first concentration of ions to an electrochemical cell;
electrochemically absorbing the ions from the first aqueous solution into an electrode of the electrochemical cell to form a second aqueous solution comprising a second concentration of the ions, the second concentration being less than the first concentration;
discharging the second aqueous solution from the electrochemical cell;
providing a third aqueous solution comprising a third concentration of the ions to the electrochemical cell;
electrochemically desorbing the ions from the electrode of the electrochemical cell into the third aqueous solution to form a fourth aqueous solution comprising a fourth concentration of the ions, the fourth concentration being greater than the third concentration;
discharging the fourth aqueous solution from the electrochemical cell; and
forming inorganic carbon species from a CO₂ source.

2. The method of claim 1, wherein the first aqueous solution is sourced from a first waterbody, and the third aqueous solution is sourced from a second waterbody.

3. The method of claim 1 or 2, wherein the first waterbody and second waterbody are sourced from the same waterbody.

4. The method of any one of claims 1 to 3, wherein the first waterbody and second waterbody are sourced from different waterbodies.

5. The method of any one of claims 1 to 4, wherein the first waterbody comprises a surface water, an intermediate water, a deep water, or a subterranean water.

6. The method of any one of claims 1 to 5, wherein the first waterbody comprises freshwater, brackish water, seawater, wastewater, produced water, recycled water, subterranean water, or a combination thereof.

7. The method of any one of claims 1 to 6, wherein the second waterbody comprises a surface water, an intermediate water, a deep water, or a subterranean water.

8. The method of any one of claims 1 to 7, wherein the second waterbody comprises freshwater, brackish water, seawater, wastewater, produced water, recycled water, subterranean water, or a combination thereof.

9. The method of any one of claims 1 to 8, wherein the ions comprise alkali metal cations, alkaline earth metal cations, or a combination thereof.

10. The method of any one of claims 1 to 9, wherein the ions comprise halide anions, polyatomic anions, or a combination thereof.

11. The method of any one of claims 1 to 10, wherein the electrochemical cell comprises a galvanic cell, voltaic cell, an electrolytic cell, a fuel cell, a battery, or a combination thereof.

12. The method of any one of claims 1 to 11, wherein the electrochemical cell comprises a counter electrode, the counter electrode comprising a gas-evolving electrode.

13. The method of claim 12, wherein the gas-evolving electrode produces hydrogen gas and hydroxide anions.

14. The method of any one of claims 1 to 11, wherein the electrochemical cell comprises a counter electrode, the counter electrode comprising a hydrogen-storing electrode.

15. The method of claim 14, wherein the electrochemical cell is a battery.

16. The method of any one of claims 1 to 15, further comprising discharging the hydroxide anions from the electrochemical cell and increasing concentration of the inorganic carbon species formed from the CO₂ source.

17. The method of any one of claims 1 to 16, wherein the CO₂ source comprises a CO₂-comprising gas, a dissolved CO₂, or a combination thereof.

18. The method of any one of claims 1 to 17, wherein the CO₂ source comprises air, anthropogenic CO₂-comprising gases, or CO₂ dissolved therefrom.

19. The method of any one of claims 1 to 18, further comprising storing the inorganic carbon species.

20. The method of claim 19, wherein storing the inorganic carbon specifies comprises storing in a water or a reservoir.

21. The method of claim 20, wherein the water comprises freshwaters, brackish waters, seawaters, or a combination thereof.

22. The method of claim 20 or 21, wherein the water comprises a surface water.

23. The method of any one of claims 20 to 22, wherein the reservoir comprises a subterranean reservoir.

24. The method of claim 1 to 23, wherein forming the inorganic carbon species comprises forming the inorganic carbon species in a surface water.

25. The method of claim 24, wherein forming the inorganic carbon species comprises forming the inorganic carbon species from atmospheric CO₂ in contact with the surface water.

26. The method of claim 24 or 25, wherein forming the inorganic carbon species comprises forming the inorganic carbon species from atmospheric CO₂ dissolved in the surface water.

27. The method of any one of claims 24 to 26, wherein providing the first aqueous solution comprises providing the first aqueous solution from a first position distanced from the surface water.

28. The method of any one of claims 24 to 27, wherein discharging the fourth aqueous solution comprises discharging the fourth aqueous solution to a second position distanced from the surface water.

29. The method of any one of claims 24 to 28, wherein when the ions comprise alkali metal cations, alkaline earth metal cations, or a combination thereof, the first position distanced from the surface water is distal from the surface water, and the second position distanced from the surface water is within the surface water.

30. The method of any one of claims 24 to 28, wherein when the ions comprise halide anions, polyatomic anions, or a combination thereof, the first position distanced from the surface water is within the surface water, and the second position distanced from the surface water is distal to the surface water.

31. The method of any one of claims 24 to 30, wherein providing the third aqueous solution comprises providing the third aqueous solution from a third position distanced from the surface water.

32. The method of claim 31, wherein the third position comprises a position proximal or equivalent to the first position; a position proximal or equivalent to the second position; or a position between the first and second positions.

33. The method of any one of claims 24 to 32, wherein providing the first aqueous solution to the electrochemical cell comprises:
moving the electrochemical cell to the first position distanced from the surface water; or
fluidly communicating the first aqueous solution to the electrochemical cell from the first position distanced from the surface water.

34. The method of any one of claims 24 to 33, wherein discharging the fourth aqueous solution from the electrochemical cell comprises:
moving the electrochemical cell from the first position to the second position distanced from the surface water; or
fluidly communicating the fourth aqueous solution from the electrochemical cell to the second position distanced from the surface water.

35. The method of any one of claims 24 to 34, wherein providing the third aqueous solution to the electrochemical cell comprises:
moving the electrochemical cell to the third position distanced from the surface water; or
fluidly communicating the third aqueous solution to the electrochemical cell from the third position distanced from the surface water.

36. The method of any one of claims 24 to 35, wherein, when the ions comprise alkali metal cations, alkaline earth metal cations, or a combination thereof, forming the inorganic carbon species comprises increasing concentrations of the inorganic carbon species in the surface water following discharging the fourth aqueous solution to the second position distanced from the surface water.

37. The method of any one of claims 24 to 35, wherein, when the ions comprise halide anions, polyatomic anions, or a combination thereof, forming the inorganic carbon species comprises increasing concentrations of the inorganic carbon species in the surface water following discharging the second aqueous solution from the electrochemical cell.

38. The method of claim 37, wherein discharging the second aqueous solution from the electrochemical cell comprises discharging within the surface water.

39. The method of claim 37 or 38, wherein discharging the second aqueous solution from the electrochemical cell comprises:
moving the electrochemical cell to be positioned within the surface water; or
fluidly communicating the second aqueous solution from the electrochemical cell to within the surface water.

40. The method of any one of claims 24 to 39, wherein, when the electrochemical cell comprises the gas-evolving electrode, the method further comprises producing hydrogen gas and hydroxide anions.

41. The method of claim 40, further comprising providing the hydroxide anions to the surface water, and increasing concentrations of inorganic carbon species in the surface water.

42. The method of any one of claims 24 to 41, wherein the surface water comprises freshwater, brackish water, seawater, wastewater, produced water, recycled water, or a combination thereof.

43. The method of any one of claims 24 to 42, wherein the surface water comprises freshwater, brackish water, seawater, or a combination thereof.

44. The method of any one of claims 24 to 43, wherein, when the ions comprise alkali metal cations, alkaline earth metal cations, or a combination thereof, the first position distanced from the surface water is within intermediate or deep water, and the second position distanced from the surface water is within the surface water.

45. The method of any one of claims 24 to 43, wherein when the ions comprise halide anions, polyatomic anions, or a combination thereof, the first position distanced from the surface water is within the surface water, and the second position distanced from the surface water is within intermediate or deep water.

46. The method of claim 1 to 23, wherein forming the inorganic carbon species comprises forming the inorganic carbon species in a subterranean water.

47. The method of claim 46, wherein providing the first aqueous solution comprises providing the first aqueous solution from a first subterranean reservoir.

48. The method of claim 46 or 47, wherein providing the third aqueous solution comprises providing the third aqueous solution from the first subterranean reservoir, a second subterranean reservoir, or a combination thereof.

49. The method of any one of claims 46 to 48, wherein, when the ions comprise alkali metal cations, alkaline earth metal cations, or a combination thereof, forming the inorganic carbon species comprises forming the inorganic carbon species by contacting the discharged fourth aqueous solution with the CO₂ source.

50. The method of claim 49, wherein contacting the discharged fourth aqueous solution with the CO₂ source comprises sparging, or equilibrating the discharged fourth aqueous solution with the CO₂ source.

51. The method of any one of claims 46 to 48, wherein when the ions comprise halide anions, polyatomic anions, or a combination thereof, forming the inorganic carbon species comprises forming the inorganic carbon species by forming the inorganic carbon species by contacting the discharged second aqueous solution with the CO₂ source.

52. The method of claim 51, wherein contacting the discharged second aqueous solution with the CO₂ source comprises sparging, or equilibrating the discharged second aqueous solution with the CO₂ source.

53. The method of any one of claims 46 to 52, wherein discharging the fourth aqueous solution comprises discharging the fourth aqueous solution to the first subterranean reservoir, the second subterranean reservoir, a third subterranean reservoir, or a combination thereof.

54. The method of any one of claims 46 to 53, wherein discharging the second aqueous solution comprises discharging the second aqueous solution to the first subterranean reservoir, the second subterranean reservoir, the third subterranean reservoir, a fourth subterranean reservoir, or a combination thereof.

55. The method of any one of claims 46 to 54, wherein providing the first aqueous solution to the electrochemical cell comprises:
fluidly communicating the first aqueous solution to the electrochemical cell from the first subterranean reservoir.

56. The method of any one of claims 46 to 55, wherein providing the third aqueous solution to the electrochemical cell comprises:
fluidly communicating the third aqueous solution to the electrochemical cell from the first subterranean reservoir, the second subterranean reservoir, or a combination thereof.

57. The method of any one of claims 46 to 56, wherein discharging the fourth aqueous solution from the electrochemical comprises:
fluidly communicating the fourth aqueous solution from the electrochemical cell to the first subterranean reservoir, the second subterranean reservoir, the third subterranean reservoir, or combination thereof.

58. The method of any one of claims 46 to 57, wherein discharging the second aqueous solution from the electrochemical cell comprises:
fluidly communicating the fourth aqueous solution from the electrochemical cell the first subterranean reservoir, the second subterranean reservoir, the third subterranean reservoir, the fourth subterranean reservoir, or a combination thereof.

59. The method of any one of claims 46 to 58, wherein the CO₂ source comprises air, an anthropogenic CO₂-comprising gas, a dissolved CO₂, or a combination thereof.

60. The method of any one of claims 46 to 59, wherein any one or combination of the first subterranean reservoir, the second subterranean reservoir, the third subterranean reservoir, the fourth subterranean reservoir comprises a geothermal reservoir, a drilled well, an oil and gas well, a reinjection well, or a combination thereof.

61. A electrochemical cell configured to perform the method of any one of claims 1 to 60, the cell comprising a working electrode and a counter electrode, the counter electrode comprising a hydrogen-storing electrode.

62. The cell of claim 61, wherein the hydrogen-storing electrode comprises MoS₂; Mg, Ni, and/or Co alloys; MoS₂-carbon composites; Mg, Ni, and/or Co alloy-carbon composites; or a combination thereof.

63. The cell of claim 61 or 62, wherein carbon of the carbon composites comprises graphene, fullerene, carbon nanotubes, or a combination thereof.

64. The cell of any one of claims 61 to 63, wherein the working electrode comprises a cation adsorbing/desorbing electrode, or an anion adsorbing/desorbing electrode.

65. The cell of any one of claims 61 to 64, wherein the working electrode comprises Prussian blue analogue electrodes, metal oxides electrodes, polymer-based electrodes, metal sulfide electrodes, metal phosphate electrodes, carbon-based electrodes, MXene electrodes, alloying-type electrodes, or a combination thereof.

66. The cell of any one of claims 61 to 65, for use as a battery.

67. A system configured to perform the method of any one of claims 1 to 60.

68. A system, comprising:
an electrochemical cell, the electrochemical cell configured for
accepting a first aqueous solution comprising a first concentration of ions,
electrochemically absorbing the ions from the first aqueous solution into an electrode of the electrochemical cell to form a second aqueous solution comprising a second concentration of the ions, the second concentration being less than the first concentration,
discharging the second aqueous solution from the electrochemical cell;
accepting a third aqueous solution comprising a third concentration of the ions;
electrochemically desorbing the ions from the electrode of the electrochemical cell into the third aqueous solution to form a fourth aqueous solution comprising a fourth concentration of the ions, the fourth concentration being greater than the third concentration, and
discharging the fourth aqueous solution from the electrochemical cell; and
a mass transport device coupled to the electrochemical cell for providing the first aqueous solution and/or the third aqueous solution, and discharging the second aqueous solution and/or the fourth aqueous solution.

69. The system of claim 67 or 68, wherein the system is powered by renewable energy sources.

70. The system of claim 68 or 69, wherein the mass transport system comprises pumps and pipes in fluid communication with the electrochemical cell, for providing the first aqueous solution and/or the third aqueous solution to the electrochemical cell and discharging the second aqueous solution and/or the fourth aqueous solution from the electrochemical cell.

71. The system of any one of claims 68 to 70, wherein the mass transport system comprises an autonomous submersible vehicle for positioning the electrochemical cell at a first distance from a surface water, and/or for positioning the electrochemical cell at a second distance from a surface water.

72. The system claim 71, wherein
the first distance from the surface water is distal from the surface, and the second distance from the surface water is proximal to the surface; or
the first distance from the surface water is proximal from the surface, and the second distance from the surface water is distal to the surface.

73. The system of claim 71 or 72, wherein the first distance or the second distance is proximal to an underwater seamount.

74. The system of any one of claims 68 to 73, wherein the electrochemical cell comprises a galvanic cell, voltaic cell, an electrolytic cell, a fuel cell, a battery, or a combination thereof.

75. The system of any one of claims 68 to 74, wherein the electrochemical cell comprises a counter electrode, the counter electrode comprising a gas-evolving electrode.

76. The system of any one of claims 68 to 75, wherein the electrochemical cell comprises a counter electrode, the counter electrode comprising a hydrogen-storing electrode.

77. The system of claim 76, wherein the electrochemical cell is a battery.
